(19) United States
(12) Patent Application Publication
(10) Pub. No.: US 2026/0119907 A1
(43) Pub. Date: Apr. 30, 2026

(54) SYSTEM AND METHOD OF ON THE BOX ARTIFICIAL INTELLIGENCE PRODUCTIVITY TOOL ORCHESTRATING AT AN OPERATING SYSTEM LEVEL DISK WIPING REQUIRING BOOT UP INTO BASIC INPUT OUTPUT SYSTEM

(71) Applicant: Dell Products LP, Round Rock, TX (US)

(72) Inventors: Srikanth Kondapi, Austin, TX (US); Purushothama R. Malluru, Round Rock, TX (US); Jacob Mink, Cedar Park, TX (US)

(73) Assignee: Dell Products LP, Round Rock, TX (US)

(21) Appl. No.: 18/929,530

(22) Filed: Oct. 28, 2024

(51) Int. Cl. G06N 5/01

(52) U.S. Cl. CPC G06N 5/01

(57) ABSTRACT

An information handling system executing computer readable code instructions for an on the box artificial intelligence (AI) productivity tool comprising a hardware processor receiving a user query input requesting erasing a drive memory of the information handling system, executing computer-readable code instructions to perform a semantic similarity search at a main operating system (OS) level comparing a generated query input intent value to capability intent values generated from natural language descriptions of secondary OS capabilities and other software capabilities to identify a best match secondary OS capability for the received user query input having a highest semantic similarity search score, storing the best match secondary OS capability in a non-volatile shared memory mailbox location, rebooting into a secondary lightweight OS executing a secondary OS AI productivity tool to retrieve the best match secondary capability for execution by the secondary lightweight OS to erase the drive memory.

### CROSS REFERENCE TO RELATED APPLICATIONS

This application is a related to U.S. Patent Application No. XX/XXX,XXX, entitled “SYSTEM AND METHOD OF ON THE BOX ARTIFICIAL INTELLIGENCE PRODUCTIVITY TOOL ORCHESTRATING AND MAINTAINING CONTINUOUS USER CHAT THROUGHOUT BOOT UP INTO A BASIC INPUT OUTPUT SYSTEM,” filed on October 28, 2024, Attorney Docket Number DC-138777, invented by Srikanth Kondapi, et al., and assigned to the assignee hereof.

### FIELD OF THE DISCLOSURE

The present disclosure generally relates to an on the box (OTB) artificial intelligence (AI) productivity tool executing at the main operating system (OS) level that employs machine learning models stored at an information handling system for optimizing user productivity and information handling system performance in response to a received user query input. The present disclosure more specifically relates to the OTB AI productivity tool orchestrating execution of a process, such as disk wiping, disk cloning, resetting the main operating system, repairing a hardware component, or backing up specifically identified data to an external memory device with a secondary lightweight operating system executing via a secondary OS AI productivity tool operating at the secondary lightweight OS, such as a service OS, of the information handling system.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more artificial intelligence (AI) productivity tool enableable software applications, chat bots, or the like. Further, the information handling system may include an on the box (OTB) artificial intelligence (AI) productivity tool employing machine learning models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing machine readable code instructions for an on the box (OTB) artificial intelligence (AI) productivity tool for orchestrating execution of a process at the secondary lightweight operating system (OS) of the information handling system following a reboot into the basic input output system (BIOS) and secondary lightweight OS according to an embodiment of the present disclosure;

FIG. 2 is a block diagram illustrating a hardware processor executing machine readable code instructions for an OTB AI productivity tool to instruct, following a reboot into BIOS and the secondary lightweight OS, a secondary OS AI productivity tool to execute a secondary OS capability that is responsive to a received user query input at the user main operating system (OS) level according to an embodiment of the present disclosure;

FIG. 3 is a block diagram illustrating a hardware processor executing machine readable code instructions for a secondary OS AI productivity tool for executing a secondary OS capability responsive to a user query input received at the main OS level and continuing a chat session initiated at the main OS level via an OTB AI productivity tool according to an embodiment of the present disclosure;

FIG. 4A is a flowchart showing a method of determining one or more best match secondary OS capabilities from a secondary lightweight OS, via an on OTB AI productivity tool executing at the main OS level in an information handling system according to an embodiment of the present disclosure;

FIG. 4B is a flowchart showing a method of automating reboot into and execution of one or more responsive secondary OS capabilities from a secondary lightweight, via an on OTB AI productivity tool executing at the main OS level, and maintaining a single user chat session across the main OS level and the secondary OS in an information handling system according to an embodiment of the present disclosure;

FIG. 4C is a flowchart showing a method of identifying a best match data storage capability, via a secondary lightweight OS executing at an information handling system according to an embodiment of the present disclosure; and

FIG. 4D is a flowchart showing a method of automating reboot into and execution of one or more responsive secondary OS capabilities for a secondary lightweight OS, via an OTB AI productivity tool executing at the main OS level, and maintaining a single user chat session across the main OS level and the secondary lightweight OS in an information handling system according to embodiments of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Artificial intelligence (AI) is a developing technology that is used to increase efficiency of computing systems and interactions with humans. An example of AI technologies includes, but is not limited to, chat-enabled environments (voice, text, etc.). These chat-enabled environments are described in embodiments herein as an on the box (OTB) AI productivity tool that receives this voice or text input from a user and implements a number of actions or utilizes services of various software applications based on the natural language of the input. In some information handling systems, the OTB AI productivity tool may interface with various AI productivity tool-enablable software applications being executed or executable on the information handling system. These AI productivity tool-enablable software applications may integrate with the OTB AI productivity tool to allow user queries to trigger certain actions declared, supported, and managed by these AI productivity tool-enablable software applications. Further, the OTB AI productivity tool executing at the main operating system level may work in tandem with an agent, referred to herein as a secondary OS AI productivity tool, to allow the same user queries to trigger certain actions declared and supported by a secondary lightweight operating system (OS) executing upon reboot to BIOS of the information handling system. Such a secondary lightweight OS in embodiments herein may act as a secondary OS AI productivity tool enableable software application and have limited capabilities such as operating to perform certain tasks, for example, that require reboot from the user main operating system (OS) level to the basic input output system (BIOS), such as disk wiping, disk cloning, resetting the main operating system, repairing a hardware component via a secondary lightweight OS, or backing up specifically identified data to an external memory device. The secondary lightweight OS executes via a hardware processor, such as a central processing unit, on the information handling system separately and non-simultaneously with the main OS to perform several such tasks that require reboot to BIOS. Upon reboot to BIOS, this secondary lightweight OS initiates instead of the main OS to perform such capabilities in embodiments herein. An example of a secondary lightweight OS may be a Service OS system on an information handling system.

A hardware processor executing code instructions of the OTB AI productivity tool at the main OS level in embodiments herein may match user queries, or user query inputs, received via a universal user conversational interface software application to known secondary OS capabilities of the secondary lightweight OS through execution by the hardware processor of machine readable code instructions for one or more natural language processing machine learning models executing at the main operating system. The natural language processing machine learning (ML) models at the main OS level may have similar but more robust operations than natural language processing machine learning models executing at the secondary lightweight OS via a secondary OS AI productivity tool used to maintain user chat sessions following reboot from the main OS level into the BIOS and the secondary lightweight OS, as described in embodiments herein. For example, the hardware processor executing code instructions of the OTB AI productivity tool executing at the main operating system level through execution by the hardware processor of machine readable code instructions for a semantic search methodology in embodiments herein may match received user query inputs to known main OS level capabilities of AI productivity tool-enableable software applications as well as certain published secondary OS capabilities, the latter of which may trigger transition to BIOS and secondary lightweight OS for execution.

The secondary OS AI productivity tool executing following reboot from the main OS level into BIOS and the secondary lightweight OS may use a lexical search methodology in an example embodiment. Lexical search methodologies such as that employed by the secondary OS AI productivity tool in embodiments are better for low-compute environments such as with limited sets of secondary OS capabilities, but lack the ability to determine context of the various keywords identified within the user query input. For example, TF-IDF methodologies cannot discern between different meanings for the same word or identify synonyms for keywords, which people routinely employ in natural language conversation. This may result in limits for matching between natural language text excerpts, such as the user query input and the software service or function described in a natural language capability for an AI productivity tool-enableable software application or for secondary OS capabilities. In embodiments herein, a hardware processor may execute machine readable code instructions for a semantic similarity search machine learning model at the main OS level via the OTB AI productivity tool that analyzes and weighs context and relevancy to overcome this disadvantage of TF-IDF methodologies, and may include published secondary OS capabilities searchable at the main OS level.

As a first step in such a semantic search methodology, a hardware processor executing machine readable code instructions for a capability intent value generator of the OTB AI productivity tool at the main OS level may determine capability intent values associated with the natural language descriptions of the gathered secondary OS capabilities as well as capabilities for each of a plurality of AI productivity tool-enablable software applications. These capability intent values are a mathematical representation of secondary OS capability operations or services at the secondary lightweight OS as well as of main OS level capabilities from various AI productivity tool-enablable software applications in embodiments herein for use in semantic search similarity comparison methodologies. These capability intent values may be represented by a mathematical value in a multi-axis vector space that may be associated with a natural language description for that secondary OS capability or for capabilities of various AI productivity tool-enableable software applications at the main OS level. In an embodiment, the secondary OS capabilities or main OS level capabilities of AI productivity tool-enableable software applications may be associated with an identification (ID) such as an alphanumeric ID that also may be stored within a capability intent values database. Generating such capability intent values as vectors may be a first step in a natural language processing method to determine and correlate the user’s query intent or requested action within a user query input that takes into account the context or semantics of the words used within the user query input with one of a plurality of secondary OS capabilities that must be executed at a BIOS level in an example embodiment. Capability intent values are also used by the OTB AI productivity tool for main OS level capabilities available from any AI productivity tool-enableable software applications that may operate in the information handling system.

Upon initiation of a user chat session, via a universal user conversational interface software application operating at the main OS level, the user query input data is transferred to the OTB AI productivity tool executing at the main OS level at a hardware processor. The hardware processor executes code instructions of a query intent determination module of the OTB AI productivity tool to determine a vectorized query input intent value for the user query input that may be comparable to the capability intent values for the secondary OS capabilities executing at the secondary lightweight OS for a responsive capability intent action to the user query input. In other aspects, capability intent values are also published for capabilities of AI productivity tool-enableable software applications at the main OS level that may be responsive. The hardware processor executing machine readable code instructions for a query intent to capability determination module of the OTB AI productivity tool in embodiments herein may then compare the vectorized user query input intent value and the capability intent values stored within the capability intent values database. Such a comparison may be performed using a semantic search machine learning model, such as a cosine similarity search that compares the distance or value difference in a multi-axis vector space between two vectors (e.g., the capability intent value vector and the user query input value vector) to determine the contextual similarity between the natural language description of the capability and the natural language user query input. Such a contextual or semantic search methodology may take into account the fact that the same word may have two meanings or consider synonyms of words, for example.

This may be performed for several of the capability intent values stored within the capability intent value database to identify a capability intent value that most closely matches the user query input value. In such a way, a hardware processor executing code instructions for the query intent to capability module for the OTB AI productivity tool may take relevance and context of natural language within a user query input into account when determining a matching secondary OS capability of a secondary lightweight OS or a main OS capability of a AI productivity tool-enableable software application that is most likely to address the user’s intent within the user query input. The natural language secondary OS capability or capability of an AI productivity tool-enableable software application having the highest semantic similarity search score may then be identified, via execution of machine readable code instructions of the query intent to capability determination module by the hardware processor as the best match secondary OS capability or AI productivity tool-enableable software application capability most likely to address the user’s intended request within the natural language user query input.

In some embodiments, execution of a best match secondary OS capability of the secondary lightweight OS may require reboot into BIOS for such an execution. For example, in existing systems, actions such as disk wiping, disk cloning, resetting the main operating system, and repairing a hardware component via the secondary lightweight OS, such as a service OS, may be performed by booting into BIOS and launching secondary lightweight OS operating as a lightweight service OS system on the hardware processor for enabling a limited set of tasks to maintain the information handling system that require the main OS to not be operating. In some cases, such a secondary lightweight OS may be executed as machine readable code instructions stored to an operatively coupled external memory device, such as a universal serial bus (USB) drive, or to a portion of the hard disk or solid state disk that is partitioned from the main operating system and all user data. The OTB AI productivity tool operating at the main OS level in embodiments may be capable of identifying the best match secondary OS capability as one of these tasks requiring and triggering reboot into the BIOS and the secondary lightweight OS from the main OS, and may orchestrate the reboot into BIOS. The OTB AI productivity tool at the main OS level may not be available upon boot to BIOS and secondary lightweight OS but still may be responsible for monitoring and orchestrating execution of the best match secondary OS capability following such a reboot by working in tandem with a secondary OS AI productivity tool. The secondary OS AI productivity tool upon reboot to BIOS and secondary lightweight OS may also maintain a single user chat session throughout such a reboot for coordination with the OTB AI productivity tool at the main OS level later and any following reboots between the OS and the secondary lightweight OS until the user’s query input has been satisfied.

The OTB AI productivity tool in embodiments herein may save an executable version of the best match secondary OS capability identification into a designated portion in random access memory (RAM) or a file disk partition accessible by the hardware processor executing the secondary lightweight OS and the secondary OS AI productivity tool executing at the secondary lightweight OS. An instruction for the secondary OS AI productivity tool to orchestrate execution of such a saved best match secondary OS capability identification may also be stored in a mailbox memory location in RAM or a disk partition by the OTB AI productivity tool, for retrieval and execution by the secondary OS AI productivity tool following reboot from the OS to the BIOS and secondary lightweight OS, as orchestrated by the OTB AI productivity tool. The mailbox memory location in RAM or a disk partition of disk memory may be accessible by both the OTB AI productivity tool executing from the main OS level as well as the secondary OS AI productivity tool and secondary lightweight OS separately executing at the information handling system in embodiments herein.

In another aspect of embodiments herein, the OTB AI productivity tool and the secondary OS AI productivity tool may work in tandem to maintain a continuous user chat session throughout one or more reboots between the OS and the BIOS and the secondary lightweight OS, as needed for proper execution of the best match secondary OS capabilities identified as responsive to received user query inputs, via storage and retrieval from the commonly accessible mailbox memory location in RAM or disk partition. For example, prior to reboot into BIOS and the secondary lightweight OS, the OTB AI productivity tool operating at the OS may store in the mailbox memory location in RAM or a disk partition that is also accessible by the secondary OS AI productivity tool, a current chat session history, including all communications with the user transmitted and received via the universal user conversational interface software application in the current user chat session, including the received user query input from which the best match secondary OS capability has been determined. Upon reboot into BIOS and automatic startup of the secondary OS AI productivity tool in embodiments herein, the secondary OS AI productivity tool may retrieve the stored chat session history from the mailbox memory location in RAM or the disk partition and continue the user chat session initiated at the main OS level via a secondary OS conversational interface. The user, via this secondary OS conversational interface may then request execution of further secondary OS capabilities, such as data backup, prior to execution of the best match secondary OS capability identified at the main OS level by the OTB AI productivity tool as responsive to the user query input received at the main OS level prior to reboot into the BIOS. The user may also use this secondary OS conversational interface to provide final approval for execution of the best match secondary OS capability, for example.

Upon access of the stored user query input in the stored chat session history from the mailbox memory location in RAM or the disk partition by the secondary OS AI productivity tool and secondary OS conversational interface in embodiments herein, such as those described directly above, the received user query input data (audio, video or text) and any determined best match secondary OS capabilities identified as responsive to received user query input is routed to the hardware processor executing the secondary lightweight OS. Additional user query inputs may be received as part of the ongoing chat at the secondary OS conversational interface from the microphone, camera, keyboard, or other input in embodiments as well. With the current user query input, secondary OS AI productivity tool determines execution of the secondary OS capability intent action for the best match secondary OS capabilities identified as responsive to received user query inputs.

In one example embodiment, the best match secondary OS capabilities identified as responsive to received user query inputs from determination of a user’s instruction to store or backup data to an external memory device. The hardware processor will execute the secondary OS AI productivity tool at the secondary lightweight OS to match the received user query input and the best match secondary OS capabilities identified at the main OS level, if any, to a data storage capability using lexical similarity determination for a user query intent and matching the user query intent to a library of available secondary OS capabilities, including data storage capabilities according to embodiments herein. In some embodiments, the secondary OS AI productivity tool may receive a new user query input while in the secondary lightweight OS and execute to match the received user query input to a new or additional best match secondary OS capabilities.

This may include gathering, either in real-time or prior to execution of either the OTB AI productivity tool or the secondary OS AI productivity tool, secondary OS capabilities, including data storage capabilities. The natural language descriptions of the secondary OS capabilities may be identified, by a manufacturer or information technology decision maker (ITDM), and stored within a natural language capability library within a partitioned accessible memory of the hardware processor for a lexical comparison, via the hardware processor executing the secondary lightweight OS, to received user query inputs, for example, in order to identify a data storage capability most likely to address a user’s data storage request within the received user query inputs following reboot into BIOS and the secondary lightweight OS. Similarly, some natural language descriptions of the secondary OS capabilities may also be identified, by a manufacturer or ITDM, and stored within a natural language capability library at a database accessible at the main OS level by the OTB AI productivity tool for identification of those secondary OS capabilities requiring reboot to BIOS and secondary lightweight OS in embodiments herein.

The natural language descriptions of the secondary OS capabilities accessible by the OTB AI productivity tool at the main OS level may be stored within a natural language capability database in a main memory or a static or disk memory database for the information handling system for semantic comparison, via the hardware processor to user query inputs received prior to reboot into BIOS and the secondary lightweight OS, for example, in order to identify a secondary OS capability most likely to address a user’s request within the received user query inputs. The stored natural language descriptions of secondary OS capabilities or a static or disk memory database partitioned and accessible to the hardware processor executing the secondary lightweight OS may be condensed in comparison to the much larger database of natural language descriptions of secondary OS capabilities as well as capabilities of AI productivity tool enableable software applications at the main OS level stored in the main memory static or disk memory database and executable at the main operating system level.

In a particular example embodiment, upon receipt of a user query input requesting data storage to an external memory device that is determined to be a best match secondary OS capability, a reboot is triggered to BIOS and the secondary lightweight OS. Following reboot into BIOS and the secondary lightweight OS in embodiments herein, audio or image data of the user query input may be translated to text via an automatic speech recognition module or image recognition module operating within the firmware of the microphone or camera, respectively if the stored user query input is not already in text. The hardware processor executing code instructions of a lexical similarity search module of the secondary OS AI productivity tool at the secondary lightweight OS in embodiments may then execute a lexical similarity search method to match the natural language of the received user query input accessed from the mailbox memory location shared with the main OS level or a new user query input with a natural language description of a secondary OS capability. In an example embodiment, the secondary OS capability identified may be a data storage capability stored in the natural language capability library at the secondary lightweight OS in order for the hardware processor to identify a data storage capability that most closely corresponds and can address the user request within the user query input received or accessed in the mailbox memory location following the reboot into BIOS and the secondary lightweight OS. A lexical similarity search methodology for matching text or documents in embodiments herein may center upon keyword searches, such as term frequency-inverse document frequency (TF-IDF) searches. TF-IDF searches in this context focus upon the frequency of a term or keyword found within a user query input and within known secondary OS capabilities.

Execution of computer readable code instructions of the secondary OS AI productivity tool by a hardware processor executing the secondary lightweight OS in embodiments herein may perform such a lexical search comparing the natural language of the user query input to each of the secondary OS capability natural language descriptions stored within the natural language capability library at a memory storage accessible to the embedded controller. The secondary OS AI productivity tool executes to generate, for each of these stored secondary OS capabilities, a lexical search similarity score. A highest lexical search similarity score generated in such a manner may be identified by the secondary OS AI productivity tool as a best match data storage capability for addressing the user query input requesting data storage to an external memory device following reboot into BIOS and the secondary lightweight OS, where the user query input or inputs were received after reboot or accessed from the mailbox memory location shared with the OTB AI productivity tool from the main OS level. The secondary OS AI productivity tool in embodiments herein may then, independently of the main operating system, instruct execution of a responsive secondary OS capability intent action associated with the best match data storage capability, via the secondary lightweight OS.

Following execution of a best match data storage capability, in the example embodiment where the user has selected for such transfer of data to an external memory device, the secondary OS AI productivity tool in embodiments may prompt the user, via the secondary OS conversational interface, for final approval to execute the best match secondary OS capability in response to the user query input received prior to reboot into BIOS and the secondary lightweight OS. In other examples, the secondary OS AI productivity tool may request the user to confirm execution of other secondary OS capabilities that match user query inputs including processes such as disk wiping, disk cloning, or resetting the main operating system, repairing a hardware component via the secondary lightweight OS prior to execution of such a process. Upon receipt of user confirmation in embodiments herein, the secondary OS AI productivity tool in embodiments herein may execute the best match secondary OS capability. In such a way, the OTB AI productivity tool operating at the main OS level may orchestrate execution of secondary OS capabilities including processes, such as disk wiping, disk cloning, resetting the main operating system, repairing a hardware component via the secondary lightweight OS, or backing up specifically identified data to an external memory device, via a secondary OS AI productivity tool operating at the secondary lightweight OS of the information handling system following a reboot into the basic input output system (BIOS) and secondary lightweight OS from the main OS in coordination with an OTB AI productivity tool executing at the main OS level in embodiments of the present disclosure.

In some cases, proper execution of tasks that require reboot into BIOS and the secondary lightweight OS may require multiple reboots between the secondary lightweight OS and OS. In such a case, following execution of the best match secondary OS capability, as described directly above, the secondary OS AI productivity tool may store an execution log detailing execution of the secondary OS AI productivity tool in the secondary lightweight OS, as well as an updated user chat session history that includes all communications with the user via the secondary OS AI productivity tool following reboot into BIOS and secondary lightweight OS at the mailbox memory location in RAM or the disk partition shared with both the secondary OS AI productivity tool and the OTB AI productivity tool executing at the main OS level in embodiments of the present disclosure. This may be performed in anticipation of reboot from the secondary lightweight OS and back into the main OS. Such data may be stored in the mailbox memory location in RAM or the disk partition accessible by both the secondary OS AI productivity tool and the OTB AI productivity tool at the main OS in embodiments of the present disclosure. The secondary OS AI productivity tool in embodiments may then initiate reboot back into the main OS, whereupon the OTB AI productivity tool may retrieve such data and continue the user chat session via the universal user conversational interface software application executing at the main operating system level. In such a way, the OTB AI productivity tool may work in tandem with the secondary OS AI productivity tool to orchestrate responsive capability intent actions in both the main OS level and at the secondary lightweight OS of the information handling system and maintain an ongoing user chat session throughout one or more reboots between the OS and the secondary lightweight OS in embodiments of the present disclosure.

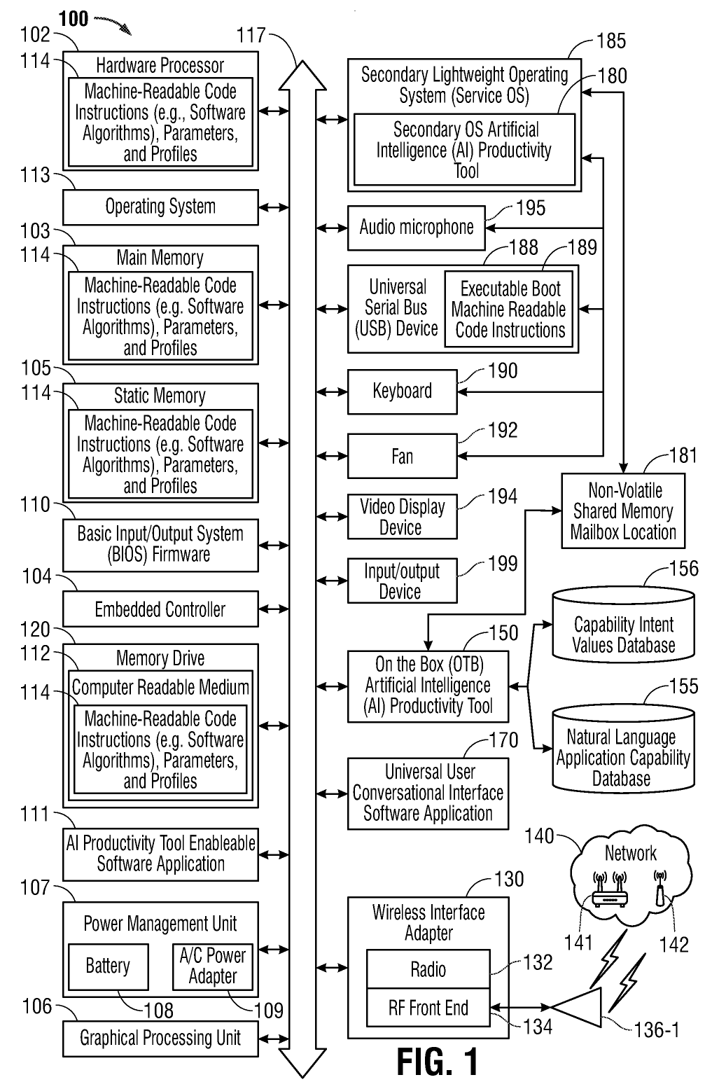

Turning now to the figures, FIG. 1 illustrates an information handling system 100 similar to the information handling systems according to several aspects of the present disclosure. As described herein, an on the box (OTB) artificial (AI) productivity tool 150 may orchestrate execution of a plural processes for capabilities of AI productivity tool enableable software applications 111 executing at the operation system level 113 as well as secondary OS capabilities executing at the secondary lightweight OS 185, such as a service OS, of the information handling system 100, such as disk wiping, disk cloning, resetting the main operating system (OS) 113, repairing a hardware component (e.g., audio microphone 195, keyboard 190, fan 192, display device 194, or other input/output device 199) , or backing up specifically identified data to an external memory device) according to embodiments of the present disclosure. Such secondary OS capabilities executing at the secondary lightweight OS 185 of the information handling system may execute via code instructions of secondary lightweight OS 185 by a hardware processor 102 or other hardware processing resource may be identified or coordinated via execution of a secondary OS AI productivity tool 180 operating at the secondary lightweight OS 185 of the information handling system 100. This may occur following a reboot into the basic input output system (BIOS) 110 and initiate of the secondary lightweight OS 185 by the hardware processor 102 separately from the main OS 113 for execution of limited set of maintenance tasks that require the main OS 113 not be operating. The OTB AI productivity tool 150 may also operate in an embodiment to maintain, via a universal user conversational interface software application 170 and in coordination with a secondary OS conversational interface of the secondary OS AI productivity tool 180, an ongoing user chat session initiated prior to such reboot, and continued following one or more reboots to and from the OS 113 and secondary lightweight OS 185. The coordination may occur via a designated and partitioned non-volatile shared memory space that is a mailbox memory location 181 in a hidden disk partition location or a pulldown via BIOS 110 connected to RAM and is securely accessible by both the secondary OS AI productivity tool at the secondary lightweight OS 185 as well as the OTB AI productivity tool 150 executing at the main OS level 113 in embodiments herein.

A secondary lightweight OS 185 in example embodiments may operate to perform certain tasks that require reboot from the OS 113 to the basic input output system (BIOS) 110 such that the main OS 113 is not executing, such as disk wiping, disk cloning, resetting the main operating system, repairing a hardware component via the secondary lightweight OS, or backing up specifically identified data to an external memory device. A hardware processor 102 executing code instructions of the OTB AI productivity tool 150 at the main OS level 113 in an embodiment may match user queries, or user query inputs, received via a universal user conversational interface software application 170 to known secondary OS capabilities of the secondary lightweight OS 185 through execution by the hardware processor 102 of machine readable code instructions for one or more natural language processing machine learning models executing semantic search methodologies at the main operating system 113 in an embodiment. This may be in addition to hardware processor 102 executing code instructions of the OTB AI productivity tool 150 at the main OS level 113 in an embodiment may match user queries, or user query inputs, received via a universal user conversational interface software application 170 to known capabilities of AI productivity tool enableable software applications 111 at the main OS 113 as well. The OTB AI productivity tool identifies the responsive capabilities from available capabilities of the AI productivity tool software applications 111 and of the secondary OS capabilities through execution by the hardware processor 102 of machine readable code instructions for one or more natural language processing machine learning models executing semantic search methodologies at the main operating system 113.

As a first step in such a semantic search methodology, a hardware processor 102 executing machine readable code instructions for the OTB AI productivity tool 150 at the OS 113 level may determine capability intent values associated with natural language descriptions of gathered secondary OS capabilities that are executable at a secondary lightweight OS 185 after a reboot and stored in the natural language application capability database 155 in an embodiment. Additionally, the natural language application capability database 155 may also contain natural language descriptions of capabilities of AI productivity tool enableable software applications 111 executing at the main OS level 113 on the information handling system 100 in embodiments herein. These capability intent values may be stored in the capability intent values database 156 in an embodiment. Generating such capability intent values as vectors may be a first step in a natural language processing method to determine and correlate the user’s query intent or requested action within a user query input within a chat history between the main OS level and execution of a secondary lightweight OS 185 that takes into account the context or semantics of the words used within the user query input with one of a plurality of secondary OS capabilities.

Upon initiation of a user chat session, via a universal user conversational interface software application 170 operating at the OS 113 level, the user query input data is transferred to the OTB AI productivity tool 150 executing at the OS 113 level at a hardware processor 102 executing code instructions of a query intent determination module to determine a vectorized query input intent value for the user query input that may be comparable to the capability intent values for the secondary OS capabilities of a secondary lightweight OS 185 as well as for capabilities of AI productivity tool enableable software applications 111 for a responsive capability intent action to the user query input. The hardware processor 102 executing machine readable code instructions may then compare the vectorized user query input intent value and the capability intent values stored within the capability intent values database 156. Such a comparison may be performed using a semantic search machine learning model, such as a cosine similarity search that compares the distance or value difference in a multi-axis vector space between two vectors (e.g., the capability intent value vector and the user query input value vector) to determine the contextual similarity between the natural language description of the capability and the natural language user query input. Such a contextual or semantic search methodology may take into account the fact that the same word may have two meanings or consider synonyms of words, for example. In embodiments of the present disclosure, the OTB AI productivity tool 150 may coordinate receipt of OS level 113 user query inputs with execution of responsive capability intent actions of secondary OS capabilities at the secondary lightweight OS 185 after reboot into BIOS 110. The natural language secondary OS capability having the highest semantic similarity search score may then be identified, via execution of machine readable code instructions of the OTB AI productivity tool 150 by the hardware processor 102 at the main OS level 113 as the best match secondary OS capability most likely to address the user’s intended request within the natural language user query input. Such a semantic similarity search may eliminate capabilities of AI productivity tool enableable software applications 111 as responsive or may additionally find responsive capabilities AI productivity tool enableable software applications 111 that semantically match as well in various embodiments.

In some cases, execution of the best match secondary OS capability may require reboot into BIOS 110 and to the secondary lightweight OS 185. For example, secondary OS capabilities executable as capability intent actions at the secondary lightweight OS 185 may include limited processes such as disk wiping, disk cloning, resetting the main operating system 113, and repairing a hardware component (e.g., audio microphone 195, keyboard 190, fan 192, display device 194, or other input/output device 199) via that secondary lightweight OS 185 may be performed by booting into BIOS 110 and opening the secondary lightweight OS 185 for a limited set of tasks, such as those that require the main OS 113 to not be executing or for linking to hardware components directly via an embedded controller 104 at the platform level. In some cases, such a secondary lightweight OS 185 may be executed as machine readable code instructions 189 stored on an operatively coupled external memory device, such as a universal serial bus (USB) drive 188, or from a portion of the main memory 103 or static memory 105 that is partitioned from the main operating system 113 and other user data.

In embodiments of the present disclosure, execution of code instructions of the OTB AI productivity tool 150 at the main OS level 113 in an embodiment may be capable of identifying the best match secondary OS capability as one of these tasks requiring reboot into the BIOS 110 and the secondary lightweight OS 185. The OTB AI productivity tool 150 may execute the identified best match secondary OS capabilities to trigger and orchestrate the reboot into BIOS 110 for execution of the best match secondary OS capability by the secondary lightweight OS 185 following such a reboot. Accordingly, the execution of code instructions of the OTB AI productivity tool 150 at the main OS level 113 may work in tandem with a secondary OS AI productivity tool 180 to maintain an ongoing single user chat session throughout such a reboot and any following reboots between the OS 113 and the secondary lightweight OS 185 until the user’s query input has been satisfied.

Thus, according to embodiments of the present disclosure, coordination between the OTB AI productivity tool 150 and the secondary OS AI productivity tool 180 may be done with shared storage at various stages of reboot between the OS 113 and secondary lightweight OS 185 by the OTB AI productivity tool 150 and the secondary OS AI productivity tool 180 of a user query input and chat history as well as any identified, responsive best match secondary OS capabilities in a non-volatile shared memory mailbox location 181 in RAM 103 or a partitioned drive location of static memory 105 or memory drive 120. The non-volatile shared memory mailbox location 181 in a secure, hidden partitioned drive location of static memory 105 or memory drive 120 via a pulldown from a designated location in RAM 103 is shared in that it is accessible by the OTB AI productivity tool 150 executing at the main OS level 113 as well as the secondary OS AI productivity tool 180 executing at the secondary lightweight OS 185 in embodiments herein. In this way, the OTB AI productivity tool 150 executing at the main OS level 113 may coordinate with the secondary OS AI productivity tool 180 executing at the secondary lightweight OS 185 to execute responsive capability intent actions of one or more best match secondary OS capabilities by the secondary lightweight OS 185 between the main OS level 113 and the secondary lightweight OS 185. The non-volatile shared memory mailbox location 181 in RAM 103 or a partitioned drive location of static memory 105 or memory drive 120 may operate as transfer of user query inputs received at either the main OS level 113 or the secondary lightweight OS 185, maintain the ongoing chat history, share any determined, responsive best match secondary OS capabilities, and maintain ongoing capability intent action execution transaction history between operations at the main OS level 113 and the secondary lightweight OS 185 in embodiments herein.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 120. The information handling system 100 may include or interface with one or more communications ports for communicating with external devices, as well as an input/output (IO) device 199, a video/graphics display device 194, an audio microphone 195 for recording user communications, or any combination thereof. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood that any or all portions of machine readable code instructions (e.g., software or firmware algorithms), parameters, and profiles 114 may operate on a plurality of information handling systems 100. In a specific embodiment, machine readable code instructions for the OTB AI productivity tool 150, a universal user conversational interface software application software application 170, a secondary OS AI productivity tool 180, a secondary lightweight OS 185, and one or more AI productivity tool enableable software applications 111 may execute locally at the information handling system 100, or on the box.

The information handling system 100 may include the hardware processor 102 such as a central processing unit (CPU) or other hardware processing resources. Any of the hardware processing resources may operate to execute machine readable code instructions 114 that are either firmware or software code. Moreover, the information handling system 100 may include memory such as main memory 103, static memory 105, and disk drive unit 120 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC 104, GPU 106, or any other hardware processing device. The information handling system 100 may also include one or more buses 117 operable to transmit communications between the various hardware components such as any combination of various I/O devices 199, 195, 190, as well as between hardware processors 102, an EC 104, GPU 106 or other, the main operating system (OS) 113, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the input/output devices 199 described herein. As described herein, the information handling system 100 further includes a video/graphics display device 194. The video/graphics display device 194 in an embodiment may function as a liquid crystal display (LCD), an organic light emitting diode (OLED), a flat panel display, or a solid-state display. It is appreciated that the video/graphics display device 194 may be wired or wireless and may be an external video/graphics display device 194 that allows a user to increase the desktop area by extending the desktop in an embodiment.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna RF front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth ® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 106, EC 104 or any other hardware processing resource and may include software agents, or other aspects or components used to execute the methods and systems described herein. Various software modules comprising application machine readable code instructions 114 may be coordinated by an OS 113, and/or via an application programming interface (API) include a unified device API described herein. An example OS 113 may include Windows ®, Android ®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 120 or static memory 105 also contain space for data storage. The disk drive unit 120 or static memory 105 may, thus, be referred to as memory drives in embodiments herein. According to further embodiments of the present disclosure, a sequestered portion of memory RAM 103 or RAM accessible to embedded controller 104, static memory 105 or drive unit 120 may be set aside as a non-volatile shared memory mailbox location 181 in RAM 103 or a partitioned drive location of static memory 105 or memory drive 120 according to embodiments herein. This non-volatile shared memory mailbox location 181 in RAM 103 or a partitioned drive location of static memory 105 or memory drive 120 may be accessible by both the OTB AI productivity tool 150 executing at the main OS level 113 as well as the secondary OS AI productivity tool 180 executing via the secondary lightweight OS 185 in embodiments herein. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 120 during execution by the hardware processor 102, EC 104, or GPU 106 of information handling system 100.

Main memory 103 or other memory of the embodiments described herein may contain computer-readable medium (not shown), such as RAM in an example embodiment. Main memory 103 may be utilized by hardware processor 102 in embodiments herein. Additional RAM 103 may be made available for execution of the secondary lightweight OS 185 in other embodiments. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 120 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 120, the hardware processor 102 (e.g., CPU), the EC 104, the GPU 106, a video/graphic display device 194, or other wired I/O devices 199 such as audio microphone195, or keyboard 190, and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 105 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

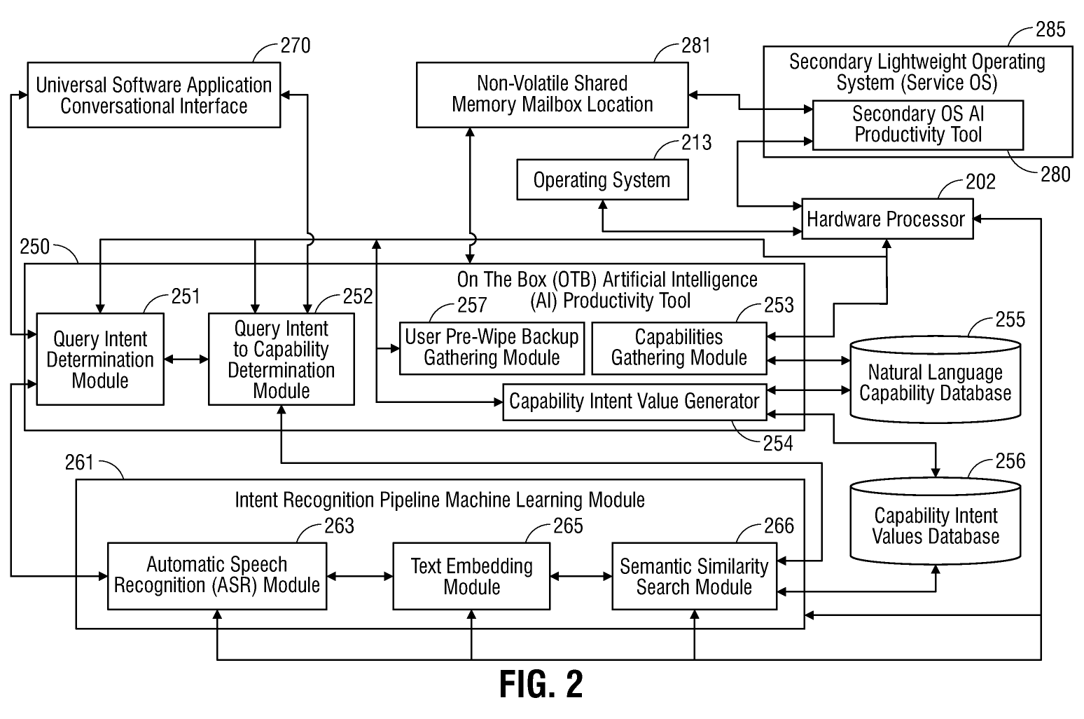

FIG. 2 is a block diagram illustrating a hardware processor executing machine readable code instructions for an on the box (OTB) AI productivity tool to instruct, following a reboot into BIOS, a secondary OS AI productivity tool to execute a secondary OS capability that is responsive to a received user query input according to an embodiment of the present disclosure. As described herein, an on the box (OTB) artificial (AI) productivity tool 250 may orchestrate execution of a responsive secondary OS capability process at a secondary lightweight OS 285, such as disk wiping, disk cloning, resetting the main operating system (OS) 213, repairing a hardware component (e.g., audio microphone 195, keyboard 190, fan 192, display device 194, or other input/output device 199 of FIG. 1) via the secondary lightweight OS 285, or backing up specifically identified data to an external memory device by access to a secondary OS AI productivity tool 280. Access between the OTB AI productivity tool 250 and the secondary OS AI productivity tool 280 executing at the secondary lightweight OS 285 occurs via a secured non-volatile shared memory mailbox location 281 in RAM or a partitioned drive location of static memory or disk drive unit in embodiments herein.

Execution of a secondary OS capability process of the secondary lightweight OS 285 as a responsive capability intent action to a received user query input may occur following a reboot into the basic input output system (BIOS) and secondary lightweight OS 285 to execute computer readable code instructions of secondary OS AI productivity tool 280 in the information handling system when a main OS 213 is not able to be executed for certain tasks. The OTB AI productivity tool 250 may also operate in an embodiment to maintain, via a universal user conversational interface software application 270 and a secondary OS conversational interface of the secondary OS AI productivity tool 280, an ongoing user chat session initiated prior to such reboot, and continued following one or more reboots to and from the main OS 213 and the OTB AI productivity tool 250 in the secondary lightweight OS 285 of the information handling system. User query inputs received at the main OS level or the secondary lightweight OS 285 may be recorded in a chat history that may be stored as well at the secured and hidden non-volatile shared memory mailbox location 281 accessible to both the OTB AI productivity tool 250 and the secondary OS AI productivity tool 280 in embodiments herein.

Computer readable code instructions of a firmware level system service tool 285 in an embodiment may execute via an embedded controller 204 to perform certain tasks that require reboot from the main OS 213 to the basic input output system (BIOS) and the secondary lightweight OS 285, such as disk wiping, disk cloning, resetting the main operating system 213, repairing a hardware component via the secondary lightweight OS 285, or backing up specifically identified data to an external memory device. A hardware processor 202 executing code instructions of the OTB AI productivity tool 250 at the main OS 213 level in an embodiment may match user queries, or user query inputs, received via a universal user conversational interface software application 270 to known secondary OS capabilities of the secondary lightweight OS 285 as well as capabilities of any AI productivity tool-enableable software applications on the information handling system through execution by the hardware processor 202 of machine readable code instructions for one or more natural language processing machine learning models executing semantic search methodologies at the main operating system 213.

As a first step in such a semantic search methodology, a hardware processor 202 executing code instructions of the OTB AI productivity tool 250 in an embodiment may match these received user queries, or user query inputs to known secondary OS capabilities and AI productivity tool-enableable software application capabilities through execution by the hardware processor 202 of machine readable code instructions for one or more natural language processing machine learning models. The AI productivity tool enableable software application executing at the main OS level 213 and the secondary lightweight OS 285 may have or publish a list of recognized AI productivity tool-enableable software application capabilities and secondary OS capabilities that they may perform in response to received user query inputs. These published lists of recognized AI productivity tool-enableable software application capabilities and secondary OS capabilities may include natural language descriptions stored in a natural language capability database 255 accessible to the OTB AI productivity tool 250. The identification of a matching secondary OS capabilities to a received user query input may trigger a reboot to BIOS and secondary lightweight OS 285 that may be required for execution of such a secondary OS capability in response to a query input received and processed by the OTB AI productivity tool 250 in embodiments herein.

The OTB AI productivity tool 250 may execute one or more ML model algorithms to identify one or more responsive AI productivity tool-enableable software application capabilities or secondary OS capabilities beginning with a query intent determination module 251 and text embedding machine learning module 265 to determine a query intent vector value in a multi-axis vector space from a user query input. The AI productivity tool-enableable software application capabilities and secondary OS capabilities are provided text descriptors that may be processed into vectorized capability intent values in a multi-axis vector space and stored at a capability intent database 256. These intent value mathematical representations of a query and a capability may be correlated by a semantic similarity matching algorithm to select a capability responsive to an input query from a user that is either from AI productivity tool-enableable software application capabilities, secondary OS capabilities, or both in embodiments herein.

This process includes gathering, either in real-time or prior to execution of the OTB AI productivity tool 250, via the capabilities gathering module 253, secondary OS capabilities. These secondary OS capabilities (also called secondary OS capability intents and having capability intent values) may describe those functionalities of the secondary lightweight OS 285 that may be stored in the capability intent values database and used when interfacing with the OTB AI productivity tool 250 for semantic similarity matching to a user query intent. Further, natural language descriptions of the secondary OS capabilities may be stored within a natural language capability database 255 for comparison to received user query inputs, for example, using lexical similarity matching in some embodiments in order to identify a secondary OS capability most likely to address a user’s request within the received user query inputs. As described in example embodiments herein, such secondary OS capabilities may include, for example, erasing some or all main memory, static memory, or a disk drive, backing up data stored on such devices (e.g., prior to erasure), cloning all data on one or more of such memory devices into a local or external memory device, performing firmware-level maintenance on one or more hardware components to address a physical malfunction, or replacing or resetting the main operating system 213, including all machine readable code instructions therefor as stored on any local memory device.

The hardware processor 202 executing machine readable code instructions of the OTB AI productivity tool 250 may determine capability intent values associated with natural language descriptions of the gathered secondary OS capabilities as well as AI productivity tool-enableable software application capabilities. In an embodiment, these capability intent values are a mathematical representation of the natural language descriptions of capability operations or services from the secondary lightweight OS 285 in an embodiment. These capability intent values may be represented by a mathematical value in a multi-axis vector space that may be associated with the natural language description for that secondary OS capability or intent. In an embodiment, the secondary OS capabilities may also be associated with an identification (ID) such as an alphanumeric ID that may be stored within a capability intent values database 256. Generating such capability intent values as vectors may be a first step in a natural language processing method to determine a secondary OS capability corresponding to and responsive to the user’s intent or requested action within a user query input that takes into account the context or semantics of the words used within the user query input.

In an embodiment, the capability intent values database 256 may store a plurality of secondary lightweight OS 285 with a name, secondary OS capability ID, natural language descriptor, or a capability intent value in some embodiments. These secondary OS capabilities stored at the capability intent values database 256 may include any input and output capabilities provided by the secondary lightweight OS 285 being executed by the hardware processor 202 or any other hardware processing devices, such as embedded controller 204. Each of the secondary OS capabilities stored at the capability intent values database 256 may have a description with text descriptors, may be associated with a unique ID, and may have a capability intent value in an embodiment.

Upon registration of a given secondary OS capability in an embodiment, a hardware processor 202 for the information handling system may execute machine readable code instructions for one or more text embedding algorithms to generate a multi-axis vector capability intent value for that secondary OS capability that, for example, may be based on text descriptors for that secondary OS capability. Each of these capability intent values for association with these capabilities may also be associated with an ID such as an alphanumeric ID that may identify, uniquely, these secondary OS capabilities in the capability intent values database 256, for example. These capability intent values may later be used to determine which of the capabilities a user intends to invoke or execute within a received user query input based on similarity with a query intent value, as described herein.

As described above, the capability intent values for natural language descriptions of secondary OS capabilities are a vectorized mathematical representation in a multi-axis vector space of the natural language descriptions of secondary OS capability operations or services of the secondary lightweight OS 285 in an embodiment, as generated using natural language processing (NLP) techniques via execution of machine readable code instructions by the hardware processor 202 of the query intent determination module 251 and the text embedding module 265. Each axis of the multi-axis vector space may provide a measurement of various attributes of a text excerpt that are known to provide context or semantic understanding of the text. For example, one or more axis values may represent a range of semantic meaning values corresponding to a reader’s understanding of a given text excerpt and further may represent the reader’s knowledge of any given word’s meaning within the text, identified phrases within the text, or the understood order or sequence of words within the text as it relates to ranges of semantic meaning values of plural axes. More specifically, one or more axis semantic values may represent the reader’s understanding as enhanced with a larger vocabulary and assigned values for which words in that vocabulary are synonyms (closer in meaning) to a given word in that text, and which words are antonyms (further away in meaning) to that given word. As another example, one or more axis semantic values may represent the reader’s ability to identify common phrases, such as “in other words” may provide greater insight to the semantic meaning of a text excerpt using this phrase than an understanding of each of the words “in,” “other,” and “words” used separately from one another would. As yet another example, one or more semantic axis values may represent the importance of the order of certain words in an excerpt may impact semantic meaning of the excerpt. More specifically, the phrase “man bites dog” may have a completely different semantic or contextual meaning than the phrase “dog bites man,” although each phrase has the same words, just in a different order.

Each axis of the multi-axis vector space, and thus, each value within a vector within such a multi-axis vector space may provide a measurement of these various semantic meaning attributes within a given initial or updated capability intent value in embodiments herein. Hundreds of vector axes may be the basis for the intent vector value in a multi-dimensional “space.” For example, a vector for a user query input intent value or for capability intent value may provide a measurement of similarity between any given word within the user query input or secondary OS capabilities (or AI productivity tool-enableable software application capabilities), respectively, a measurement of dissimilarity with known antonyms, identification of any given word as part of a phrase, or usage of any given word in a specific order that is known to be of importance. In such a way, the vectorized user query input intent value and capability intent values may mathematically represent a reader’s contextual or semantic understanding of the user query input and the natural language descriptors for the secondary OS capabilities. These vectors may then be compared to one another, via the hardware processor 202 executing machine readable code instructions of the semantic similarity search module 266 to determine statistical correlation, in order to understand how alike various phrases within the user query input and capabilities are, and how alike the usage of those words and phrases are to provide a context, such as influenced by the order of those words or phrases and their relation to one another, as well as other semantic factors represented in the multi-axis vector space.

The hardware processor 202 may also execute machine readable code instructions of a text embedding module 265 to detect which of these words are nouns, verbs, or commonly used sentence structures and generate a vectorized query input intent value for the user query input. These vectorized capability intent values and vectorized query input intent values may then be compared to one another, via the hardware processor 202 executing machine readable code instructions of the semantic similarity search module 266, in order to determine a statistical correlation that represents understanding how alike various phrases within the user query input and capabilities are, and how alike the usage of those words and phrases are to provide a context, such as influenced by the order of those words or phrases and their relation to one another. For example, the hardware processor 202 executing machine readable code instructions of the semantic similarity search module 266, and in some embodiments in tandem with algorithms of the text embedding module 265 may compare the vectorized query input intent value with the capability intent values stored within the capability intent value database 254 to identify a capability intent value correlated to the query input intent value, indicating that the user query input is requesting that the secondary lightweight OS 285 execute the secondary OS capability associated with that capability intent value. Such a comparison, in an embodiment, may include, for example, determining a distance or a vector value difference between the vectorized query input intent value and the vectorized capability intent value or a correlation value between the two. Examples of semantic similarity search module 266 algorithms may include, for example, a Cosine Similarity search machine learning model, a vector space model (VSM) similarity search machine learning model, or a K-Means Text Clustering similarity search machine learning model. These are only a few examples of semantic similarity search algorithms that may be employed and it is contemplated that any known or later-developed semantic similarity search algorithm may also be employed.

Upon determination of a secondary OS capability intent value for each of the gathered or registered secondary OS capabilities and AI productivity tool-enableable software application capabilities, the OTB AI productivity tool 250 may begin processing received user query inputs from the universal conversational interface software application 270 or other interface for responsive execution of one or more of the secondary OS capabilities corresponding or AI productivity tool-enableable software application capabilities to one of these capability intent values as determined with correlation matching of query intent value with a capability intent value. Such a user chat session may be initiated by the user providing input via an input/output device to the universal user conversational interface software application 270. In an example embodiment, a user may provide a user query input in the form of text or voice data (e.g., via IO device 199, keyboard 190, microphone 195 of FIG. 1) to a universal user conversational interface software application 270, executing machine readable code instructions as a chatbot with the OTB AI productivity tool 250 to simulate a conversation with the user. When a user provides a user query input in the form of text or voice data (e.g., via IO device 199, keyboard 190, microphone 195 of FIG. 1) to the universal user conversational interface software application 270, the hardware processor 202 executing machine-readable code instructions of the OTB AI productivity tool 250 in an embodiment may orchestrate assessment of the user’s intended goals within the user query input (e.g., what the user wishes to achieve with this communication) with determination of a query input intent value, and identify one or more capabilities associated with the secondary lightweight OS 285 or AI productivity tool-enableable software applications having a correlating capability intent value and that is capable of executing a response to this user query input intent. Further, the OTB AI productivity tool 250 may initiate performance of one or more tasks employing those capabilities to achieve the user-intended results to the user query input. In some embodiments, responsive capabilities associated with the secondary lightweight OS 285 may include a required task of rebooting to BIOS for initiating the secondary lightweight OS 285.

This orchestration in an embodiment may begin with the hardware processor 202 executing machine-readable code instructions of the query intent determination module 251 to receive the user query input via microphone, image, or text input, and initiate execution of machine readable code instructions for an intent recognition pipeline machine learning module 261. In an embodiment, the hardware processor 202 executing machine-readable code instructions for the intent recognition pipeline machine learning module 261 may further orchestrate any combination of a plurality of machine learning modules (e.g., 263, 265, or 266) to process the audio, image, or text input to determine the user’s intended goal or query intent within the received text or voice data of the user query input. During operation for example, the hardware processor 202 executing machine-readable code instructions of the query intent determination module 251 may load one or more machine learning models such that, for example, the text or voice input from the user may be processed through a speech recognition model 263 and/or processed through any of a plurality of natural language models (e.g., 265 or 266) or other ML models in order to determine a text of a user’s input query or an intent value of the user’s input query. For example, an automatic speech recognition (ASR) module 263, a text embedding module 265, or a semantic similarity search module 266 that work in various combinations with one another to detect a user’s audio speech input, conversion to text or detecting text, and detecting an intent, represented by generating a query intent vector value from the text of the user query input received from the universal user conversational interface software application 270 or other interface such as one specific to the secondary lightweight OS 285.

Further, the hardware processor 202 executing machine-readable code instructions of an intent recognition pipeline machine learning module 261 may orchestrate the interplay between each of the ASR module 263, text embedding module 265, and semantic similarity search module 266 to establish a query intent vector value in a multi-axis vector space defined with these machine learning models and correlate that query intent value with a corresponding capability intent value in an embodiment. Several text embedding algorithms may be used in various embodiments herein in order to provide a vectorized mathematical representation of semantic understanding for a user query input or for a capability described in natural language. For example, the text embedding module 265 may employ a Latent Semantic Analysis (LSA) or Latent Dirichlet allocation (LDA) which may define how close each of the observed terms in the received user query input are to various synonyms. As another example, the text embedding module 265 may employ a Word2Vec algorithm, which includes a neural network trained to understand which terms or phrases should be considered closer or further away from certain synonyms or antonyms. As yet another example, the text embedding module 265 may employ a fully recurrent neural network trained to consider the order of terms within the received user query input or the natural language descriptors of the capabilities for the secondary lightweight OS 285 or of capabilities associated with the AI productivity tool-enableable software applications.

In an embodiment in which the user provides text data, such an intent recognition pipeline machine learning module 261 may truncate this process to exclude processes of the ASR module 263. The hardware processor 202 executing machine-readable code instructions of the intent recognition pipeline machine learning module 261 in an embodiment may apply the text embedding module 265 to generate a query intent value as described and then return the output query intent value of the text embedding module 265 to the query intent to capability determination module 252. The query intent to capability module 252 may utilize the semantic similarity search module 266 for a correlation between the query intent value received and a stored capability intent value for a secondary OS capability or an AI productivity tool-enableable software application capability.

For example, in embodiments herein, a hardware processor 202 may execute machine readable code instructions for a semantic similarity search module 266, via a query intent to capability module 252, that compares the vectorized user query input intent value and the capability intent values stored within the capability intent values database 256. Such a comparison may be performed using a semantic search machine learning model, such as a cosine similarity or other semantic similarity search algorithm that compares the distance or value difference in a multi-axis vector space between two vectors to determine the contextual similarity between the natural language description of the embedded text algorithm generated capabilities having the capability intent values and the natural language user query input having an user query input intent value generated from an embedded text algorithm. Such a contextual or semantic search methodology may take into account the fact that the same word may have two meanings or consider synonyms of words, for example based on generated intent values of multiple words or recognized phrases or parts of speech that yield the vector intent value from the text embedding algorithm machine learning models used to generate capability and query intent vector values. The cosine similarity search comparison or other semantic similarity search algorithm may be performed for several of the capability intent values stored within the capability intent value database 256 to identify one or more best match secondary OS capability intent values that most closely matches the user query input value, according to embodiments herein. In other embodiments, the cosine similarity search comparison or other semantic similarity search algorithm may be performed for several of the capability intent values stored within the capability intent value database 256 to identify a best match capability intent values associated with capabilities of the AI productivity tool-enableable software applications.

A hardware processor 202 executing machine readable code instructions for a semantic similarity search module 266 may determine a distance, that is a value difference of the vector intent values within the multi-axis vector space between the query input intent value and each of a plurality of capability intent values. Then, for each of those determined distances, the hardware processor executing machine readable code instructions for a semantic similarity search module 266 may determine an angular similarity having a value between zero and one for the query input intent value and each of a plurality of capability intent values. This angular similarity value in an embodiment may comprise the semantic similarity search score for a given capability intent value, where zero is a worst match and one is a best match between the given capability intent value and the query input intent value.

In embodiments of the present disclosure, execution of the OTB AI productivity tool 250 may orchestrate execution of responsive capability intent actions at the secondary lightweight OS 285, and after a reboot to BIOS, in response to a received user query input. In such an example embodiment, the hardware processor 202 in an embodiment may execute machine readable code instructions of an OTB AI productivity tool 250 query intent to capability determination module 252 to identify the natural language secondary OS capability having a highest semantic similarity search score as the best match secondary OS capability for the received user query input. For example, the detected intent having a query intent value in a multi-axis vector space, such as “reset my main operating system,” “retire my system,” “erase my data,” “backup my data,” or “fix my fan” may be associated with a known secondary OS capability from the natural language capability database 255 or capability intent values database 256 at the information handling system. More specifically, the query intent “reset my main operating system” may be associated with a secondary OS capability for erasing and reinstalling the main operating system 213, based on similarity correlation between a query intent value and a capability intent value as determined by the semantic similarity search module 266. In another example, the query intent “retire my system” or the query intent “erase my data” may be associated with a secondary OS capability for erasing all data, other than the partitioned portion storing machine readable code instructions for the secondary lightweight OS and the secondary OS AI productivity tool 280 from all local memory devices. In another example, the query intent “fix my fan” may be associated with a secondary OS capability for directly instructing firmware to perform maintenance on the fan from the secondary lightweight OS 285. In still another example, the query intent “back up my data” may be associated with a secondary OS capability for storing some or all data on local memory devices onto external memory devices. As described above, these secondary OS capabilities may be registered and associated at the capability intent value database 256 in an embodiment. Each of these registered and associated secondary OS capabilities identified at the main OS level by execution of the OTB AI productivity tool may trigger a reboot to BIOS and the secondary lightweight OS 285 for execution of any responsive capability intent actions to the user query inputs by the secondary lightweight OS 285 in embodiments herein.

The natural language secondary OS capability having the highest semantic similarity search score may then be identified, via execution of machine readable code instructions of the OTB AI productivity tool 250 by the hardware processor 202 as the best match secondary OS capability most likely to address the user’s intended request within the natural language user query input. In some cases, execution of the best match secondary lightweight OS will require and trigger reboot into BIOS and the secondary lightweight OS 285 for execution of code instructions of the secondary OS AI productivity tool 280. Upon reboot to BIOS, the secondary OS AI productivity tool 280 executes to determine if a general reboot is to occur or if responsive capability intent actions are to be performed by best match secondary OS capabilities of the secondary lightweight OS 285 stored in the non-volatile shared memory mailbox location 281. The secondary OS AI productivity tool 280 has either a hidden secure memory drive location or a secure pull down location from RAM that it is directed to check in embodiments herein. Then the secondary OS AI productivity tool 280 retrieves the best match secondary OS capability or capabilities from the non-volatile shared memory mailbox location 281, if any. For example, responsive secondary OS capability intent actions for a responsive capability intent action such as disk wiping, disk cloning, resetting the main operating system 213, and repairing a hardware component (e.g., audio microphone 195, keyboard 190, fan 192, display device 194, or other input/output device 199) via a secondary lightweight OS 285 may be performed by booting into BIOS and opening the secondary lightweight OS 285 operating as a lightweight main operating system for execution of a limited set of tasks separately and when the main OS may not be executed.

The OTB AI productivity tool 250 in an embodiment may be capable of identifying the best match secondary OS capability as one of these tasks requiring reboot into the BIOS, and may orchestrate the reboot into BIOS and secondary lightweight OS 285 for execution of the best match secondary OS capability following such a reboot. The OTB AI productivity tool 250 may, thus, work in tandem with a secondary OS AI productivity tool 280 using a secured and hidden non-volatile shared memory mailbox location 281, set aside in memory or in a drive partition accessible to both, to maintain an ongoing user chat session and store any determined, matching capabilities and user query inputs throughout such a reboot and any following reboots between the main OS 213 and the secondary lightweight OS 285 until the users query input has been satisfied.

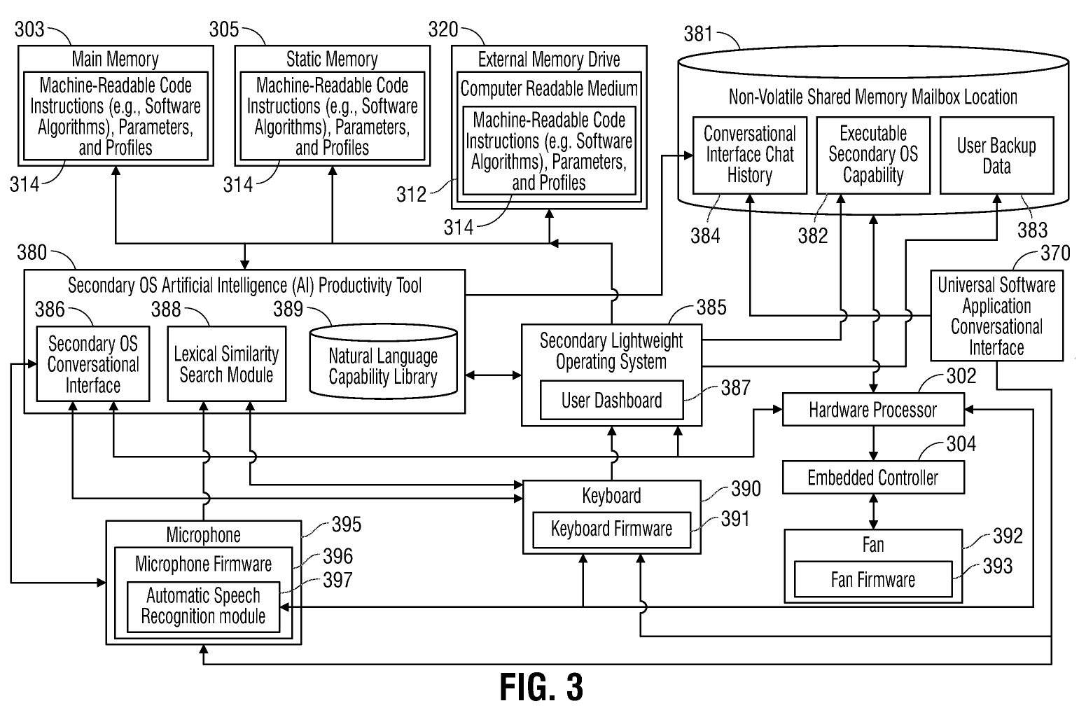

The OTB AI productivity tool 250 in an embodiment may save an executable version of the best match secondary OS capability into the non-volatile shared memory mailbox location 281 set aside in memory or in a drive partition accessible an embedded controller 204 accessible by the secondary lightweight OS 285 and the secondary OS AI productivity tool 250 executing at the secondary lightweight OS 285. An instruction for the secondary OS AI productivity tool 280 to orchestrate execution of such a saved best match secondary lightweight OS 285 capability may also be stored in the non-volatile shared memory mailbox location 281 set aside in memory or in a drive partition accessible by the OTB AI productivity tool 250, for retrieval and execution by the secondary OS AI productivity tool 280 following reboot from the main OS 213 to the BIOS and secondary lightweight OS 285, as orchestrated by the OTB AI productivity tool 250, and as described in greater detail below with respect to FIG. 3.

In another aspect of embodiments herein, the OTB AI productivity tool 250 and the secondary OS AI productivity tool 280 may work in tandem to maintain a continuous user chat session throughout one or more reboots between the main OS 213 and the secondary lightweight OS 285, as needed for proper execution of the best match secondary OS capabilities identified as responsive to received user query inputs. For example, prior to reboot into the BIOS and secondary lightweight OS 285, the OTB AI productivity tool 250 operating at the main OS 213 may store in the non-volatile shared memory mailbox location 281 set aside in memory or in a drive partition accessible by the secondary OS AI productivity tool 280, a current chat session history. Current chat session history may include all communications with the user transmitted and received via the universal user conversational interface software application 270 in the current user chat session, including the received user query input from which the best match secondary OS capability has been determined.

The hardware processor 202 in an embodiment may execute machine readable code instructions of an OTB AI productivity tool 250 to prompt a user via the universal user conversational interface software application 270 whether to back up specified user data. For example, a user may provide a natural language user query input such as “back up my hard drive,” “back up my photos,” or back up my user preferences.” If the user chooses or requests one of these data storage options, the OTB AI productivity tool 250 in an embodiment may instruct transfer or copying of such user-specified data. For example, the hardware processor 202 executing machine readable code instructions for the OTB AI productivity tool 250 may save all data from main memory or static memory to an external storage device, save data from a specifically user-identified file to an external storage device, or save data from files in main memory, static memory, or firmware named ‘preferences’ to an external storage device or to user backup data in non-volatile shared memory mailbox location 281 set aside in memory or in a drive partition. In this way, upon execution a reboot to BIOS to conduct a backup of the hard drive or a reset of the main OS 213 by the secondary OS AI productivity tool 280, the backed up specified, user files may be invoked for back up storage or repopulation after the responsive secondary OS AI productivity tool 280 capability executes one of these capability intent actions that might otherwise erase the backed up data in embodiments herein.

The hardware processor 202 may execute machine readable code instructions of the OTB AI productivity tool 250 to ask the user, via the universal user conversational interface software application 270, to confirm whether to initiate reboot into the secondary lightweight OS 285. Requesting confirmation of a request to reboot into the BIOS and secondary lightweight OS 285 may provide the user a chance to store any unsaved work or data prior to performing such a reboot, for example. If the user has chosen not to immediately reboot into the BIOS and the secondary lightweight OS 285, the OTB AI productivity tool 250 may initiate a timer, at the end of which it may prompt the user again to select when to initiate the reboot into the secondary lightweight OS 285. If the user has chosen to immediately reboot into the secondary lightweight OS 250, the OTB AI productivity tool 250 may initiate the reboot.

In some cases, proper execution of secondary OS capabilities by the secondary OS AI productivity tool 280 and secondary lightweight OS 285 that require reboot into BIOS and the secondary lightweight OS 285 and may require multiple reboots between secondary lightweight OS 285 and main OS 213. In such a case, following execution of the best match secondary OS capability, as described directly above, the secondary OS AI productivity tool 280 may store in the non-volatile shared memory mailbox location 281 an execution log detailing execution of the secondary OS capability in the secondary lightweight OS 285, as well as an updated user chat session history that includes all communications with the user via the secondary OS AI productivity tool 280 following reboot into BIOS and execution of the secondary lightweight OS 285. This may be performed in anticipation of reboot from the secondary lightweight OS 285 and back into the main OS 213. Such data may be stored in the non-volatile shared memory mailbox location 281 is accessible by both the secondary OS AI productivity tool 280 and the OTB AI productivity tool 250 in embodiments. The secondary OS AI productivity tool 280 in embodiments may then initiate reboot back into the main OS 213, whereupon the OTB AI productivity tool 250 may retrieve such data from the non-volatile shared memory mailbox location 281 and continue the user chat session via the universal user conversational interface software application 270 executing at the main operating system 213 level. In such a way, the OTB AI productivity tool 250 may work in tandem with the secondary OS AI productivity tool 280 to maintain a single user chat session throughout one or more reboots between the main OS 213 and the secondary lightweight OS 285.

FIG. 3 is a block diagram illustrating a hardware processor executing machine readable code instructions for a secondary OS AI productivity tool for executing a secondary OS capability at a secondary lightweight OS 385, following a boot into the basic input and output system (BIOS) and the secondary lightweight OS 385, as orchestrated by an OTB AI productivity tool according to embodiments herein. The hardware processor 302 executes machine readable code instructions for a secondary OS AI productivity tool 380 to execute responsive secondar OS capability intent actions by secondary OS capabilities of a secondary lightweight OS 385 as determined prior to boot to BIOS and secondary lightweight OS 385 by an OTB AI productivity tool (not shown) executing at a main OS level according to embodiments herein. Further, the secondary OS AI productivity tool 380 continues a chat session initiated at the main operating system (OS) level, via the OTB AI productivity tool according to an embodiment of the present disclosure.

Upon reboot into BIOS and automatic startup of the secondary lightweight OS 385 and secondary OS AI productivity tool 380 in an embodiment, the secondary OS AI productivity tool 380 may retrieve the stored chat session history 384 from a secured and hidden non-volatile shared memory mailbox location 381 that is set aside in memory or in a drive partition and accessible to both the secondary OS AI productivity tool 380 as well as the OTB AI productivity tool at the main OS level. The secondary OS AI productivity tool 380 with a secondary OS conversational interface 386 may then continue the user chat session initiated at the main OS level. The continuation of the user chat session by the secondary OS AI productivity tool 380 may occur via a microphone audio input or text input via keyboard received via an embedded controller and provided to the secondary OS conversational interface 386. The user, via this secondary OS conversational interface 386, may then request execution of further secondary OS capabilities from the secondary lightweight OS 385, such as data backup when needed, prior to execution of the best match secondary OS capability 382 identified at the main OS level by the OTB AI productivity tool (250 of FIG. 2) as responsive to the user query input received at the main OS level prior to reboot into the secondary lightweight OS 385. The user may also use this secondary OS conversational interface 386 to provide final approval for execution of the best match secondary OS capability 382 in another example embodiment. The secondary OS AI productivity tool 380 provides for expedient access, with low compute requirements, to conduct responsive data storage actions or other actions of a secondary lightweight OS 385 using a lexical, rather than a semantic search methodology.

Upon receipt of a user query input by the secondary OS AI productivity tool 380 and secondary OS conversational interface 386 in embodiments herein, such as those described directly above, the received user query input data (audio, video or text) is routed to the embedded controller 304 or other hardware controller from the microphone 395, keyboard 390, or other input and then to the secondary OS conversational interface 386 and secondary OS AI productivity tool 380 for determination of a user’s instruction to store or backup data to an external memory device 320 or to the non-volatile shared memory mailbox location 381 in the form of user backup data 383 stored at the non-volatile shared memory mailbox location 381. Data may be stored in either the external hard drive 320 or as user backup data 383 in the non-volatile shared memory mailbox location 381, for example, if the user wishes to reset or replace the main operating system, then migrate previously stored user data back to the newly installed main operating system. The hardware processor 302 will execute the secondary OS AI productivity tool 380 at the secondary lightweight OS 385 to match the received user query input to a data storage capability using lexical similarity determination for a user query intent and matching the user query intent to a partitioned natural language library 389 of available data storage capabilities according to embodiments herein.

The system may include gathering, either in real-time or prior to execution by an ITDM of either the OTB AI productivity tool or the secondary OS AI productivity tool 380, data storage capabilities. The natural language descriptions of the data storage capabilities for the secondary lightweight OS 385 may be stored within a natural language capability library 389 within partitioned memory accessible to the secondary OS AI productivity tool 380 for a lexical comparison to received user query inputs. The hardware processor 302 may execute code instructions of the secondary OS AI productivity tool 380, for example, in order to identify a data storage capability most likely to address a user’s data storage request within the received user query inputs following reboot into BIOS and secondary lightweight OS 385 in an embodiment.

The natural language descriptions of the data storage capabilities and other secondary OS capabilities (e.g., 382) of the secondary lightweight OS 385 are accessible by the OTB AI productivity tool at the OS from a natural language capability database (e.g., 255 in FIG. 2) in a main memory or a drive unit for the information handling system in some embodiments. According to embodiments herein, the OTB AI productivity tool at the OS accesses this natural language capability database for semantic comparison, via the hardware processor, to user query inputs received prior to reboot into BIOS and secondary lightweight OS 385, for example, in order to identify a secondary OS capability (e.g., 382) most likely to address a user’s request within the received user query inputs, as described in greater detail above with respect to FIG. 2. This provides for a more robust semantic matching to occur in response to the user query input that may trigger reboot to the BIOS and the secondary lightweight OS 385 for execution of a responsive secondary OS capability intent action as a secondary OS capability 382 in embodiments herein. Upon reboot to BIOS, the secondary OS AI productivity tool 380 executes to determine if a general reboot is to occur or if responsive secondary OS capability intent actions are to be performed by best match secondary OS capabilities 382 of the secondary lightweight OS 385 stored in the non-volatile shared memory mailbox location 381. The secondary OS AI productivity tool 380 has either a hidden secure memory drive location or a secure pull down location from RAM that it is directed to check in embodiments herein. Then the secondary OS AI productivity tool 380 retrieves the best match secondary OS capability or capabilities 382 from the non-volatile shared memory mailbox location 381, if any. Otherwise, the BIOS may continue to a dashboard 387 for the secondary lightweight OS 385 in embodiments herein.

In embodiments herein, the stored natural language descriptions of data storage capabilities or other native secondary OS capabilities within the partitioned natural language capability library 389 accessible by the limited, secondary OS AI productivity tool 385 may be condensed in comparison to the much larger database of natural language descriptions of secondary OS capabilities and AI productivity tool-enableable software applications at the main OS level that may also include data storage capabilities stored in the natural language capability database (e.g., 255 in FIG. 2) at the main OS level. In addition, the OTB AI productivity tool executing at the main operating system level may perform a semantic comparison of the user query input and each of the stored natural language descriptions of the secondary OS capabilities (e.g., 382), in addition to those of AI productivity tool-enableable software application capabilities. In embodiments of the present disclosure, the main OS level semantic comparison operates to identify a secondary OS capability 382 executable at the secondary lightweight OS 385 to perform a requested action responsive to the user query input. In contrast, the secondary OS AI productivity tool 380 executing at the secondary lightweight OS 385 may perform a less complex and less processor-intensive lexical comparison of the user query inputs received via the secondary OS conversational interface 386 following reboot into the secondary lightweight OS 385. In this latter embodiment, each of the stored natural language descriptions of secondary OS capabilities, such as data storage capabilities, native to the secondary lightweight OS 385 and the partitioned natural language capability library 389 in the partitioned portion of memory are used by the secondary OS AI productivity tool 380 lower-level comparison to identify one or more responsive secondary OS capability, such as a data storage capability executable within the secondary lightweight OS 385, to perform a requested action within the user query input received at the secondary OS conversational interface 386.

A hardware processor 302 executing code instructions of the secondary OS AI productivity tool 380 in an embodiment may match these received user queries, or user query inputs from the microphone 395, and keyboard 390 to known secondary OS capabilities, such as a data storage capability, from the partitioned natural language capability library 389 with the secondary lightweight OS 385. Execution of code instructions of the secondary OS AI productivity tool 380 may spot a keyword or keywords in user query input data through execution of machine readable code instructions for one or more natural language processing machine learning models having scaled down processing requirements and compare those lexical results with published data storage capabilities from the partitioned natural language capability library 389 accessible at the secondary lightweight OS 385.

The natural language descriptions of the data storage capabilities, including associated keywords, may be stored for a lexical or keyword comparison to received user query inputs such as an audio digital signal processing (DSP) controller, or a keyboard controller for example. Comparison by execution of computer readable code instructions of the secondary OS AI productivity tool 380 may be a lexical comparison in order to identify keywords for corresponding data storage capabilities in the partitioned natural language capability library 389 most likely to address a user’s request via execution at the secondary lightweight OS 385 responsive to the received user query inputs. These natural language descriptions of data storage capabilities stored within the partitioned natural language capability library 389 may be condensed in comparison to the much larger database of natural language descriptions of secondary OS capabilities (e.g., 382) and AI productivity tool-enableable software capabilities stored in the natural language capabilities database (e.g., 255 of FIG. 2) at the main operating system level and accessed via the OTB AI productivity tool described in greater detail above with respect to FIG. 2. The data storage capabilities or other native secondary capabilities available in the partitioned natural language capability library 389 may be limited in number and be specific to functions of the secondary lightweight OS 385 that are controlled at the secondary lightweight OS 385 independent of the main OS when the main OS cannot be executed, such as specifically for certain types of data storage tasks in embodiments herein. Storage and access of these data storage capabilities or other secondary OS capabilities at the partitioned natural language capability library 389, and their execution at the secondary lightweight OS 385 allows for scaling and expansion of available responsive capabilities to include these data storage capability actions or other native secondary OS capabilities without additional burden to the processing intensive OTB AI productivity tool executing at the main operating system level in some embodiments.

The secondary OS AI productivity tool 380 executing at the secondary lightweight OS 385 may perform a lexical or keyword comparison of the user query input and each of the natural language descriptions of the data storage capabilities or other secondary OS capabilities stored in the partitioned natural language capability library 389 to identify a best match data storage capability or other best match secondary OS capability. Such a lexical or keyword comparison in an embodiment may be less complex and less processor-intensive than the semantic similarity search performed by the OTB AI productivity tool described above with respect to FIG. 2 at the main OS level. As described herein, the user may provide a user query input via an input device, such as the microphone 395, keyboard 390 or other input device (e.g., 199 of FIG. 1) as part of an ongoing chat session after reboot to BIOS and secondary lightweight OS 385, which may be transmitted to the secondary OS conversational interface 386. Firmware 391 or 396 for the receiving input device, such as the keyboard 390 or the microphone 395 respectively, may translate a user query input to text or transmit the text user query input directly to the secondary OS AI productivity tool 380 via an embedded controller 304 or other hardware controllers at the information handling system. Upon detection of receipt of such a user query input at firmware (e.g., microphone firmware 396, or keyboard firmware 391) for the microphone 395, or keyboard 390 in an embodiment, audio, or text of the user query input may be translated to text for detection of keywords via firmware 396 or 391 of the microphone 395 or keyboard 390, respectively or transmitted to the secondary OS conversational interface 286 for the same. For example, the microphone firmware 396 may include a microphone automated speech recognition (ASR) module 397 to detect or spot words within the recorded voice data and generate text representing the detected words which may be keywords.

A hardware processer 302 executing code instructions of a lexical similarity search module 388 of the secondary OS AI productivity tool 380 in an embodiment may then perform a lexical similarity search method to match the natural language text of the received user query input with a natural language description of a data storage capability or other secondary OS capability stored in the partitioned natural language capability library 389 in order to identify a data storage capability or another secondary OS capability that most closely corresponds and can address the user request within the user query input. A lexical similarity search methodology for matching text or documents in embodiments herein may center upon keyword searches, such as term frequency-inverse document frequency (TF-IDF) searches in one embodiment. TF-IDF searches in this context focus upon the frequency of a term or keyword found within a user query input and within known data storage capabilities. TF-IDF methodologies are effective and processor non-intensive, making them well-suited when a single keyword within the user query input is most important to identifying a matching data storage capability to address the user’s needs.

In an example embodiment, the hardware processor 302 executing code instructions for the lexical similarity search module 388 may perform a TF-IDF algorithm to measure the frequency with which each of a plurality of natural language terms appear within the user query input, as weighted by the frequency with which that term occurs in one of each of the natural language data storage capabilities stored within the partitioned natural language capability library 389. More specifically, the hardware processor executing code instructions for a TF-IDF algorithm may determine a TF-IDF similarity score measuring the frequency with which each of a plurality of natural language terms appear in the user query input, as weighted by the frequency with which each of those terms also occur within each of the natural language data storage capabilities or other secondary OS capabilities stored at the partitioned natural language capability library 389. This comparison may be repeated for each of the data storage capabilities stored within the partitioned natural language capability library 389, to produce a lexical similarity search score for each of the data storage capabilities to one or more keywords detected in the user query input data. Each TF-IDF similarity score determined in such a way may have a value between zero and one. It is contemplated that any number of known or later-developed TF-IDF comparison algorithms may be used, including the best-match 25 (BM25) algorithm, the Okapi BM25 algorithm, and the BM-25 with fields (BM-25F).

Thus, for example, if there is a TF-IDF match between a term in a natural language description of a data storage capability, that data storage capability will have an increased weighting for a match over other data storage capabilities that do not contain this term in embodiments herein in an example embodiment of a user query input requesting data backup at the secondary OS AI productivity tool 380. Further, if there are multiple TF-IDF matches between a plurality of terms in a natural language description of a data storage capability, that data storage capability will have an increased weighting for a match over other data storage capabilities that only contain one matching term in embodiments herein.

As described herein, the embedded controller 304 executing code instructions for the lexical similarity search module 388 may perform a TF-IDF algorithm to measure the frequency with which each of a plurality of natural language terms of spotted keywords appear within the user query input, as weighted by the frequency with which that term occurs in one of each of the natural language data storage capabilities or other secondary OS capabilities stored within the partitioned natural language capability library 389. For example, a user may provide a natural language user query input such as “back up my hard drive,” “back up my photos,” or back up my user preferences” to the secondary OS universal conversational interface 386 as part of a continued chat session after reboot in BIOS and the secondary lightweight OS 385. In such a scenario, the hardware processor 302 executing code instructions for the lexical similarity search module 388 may determine that data storage capabilities of a secondary OS capability stored within the partitioned natural language capability library 389 such as natural language descriptions “save all data from main memory or static memory to an external storage device,” “save data from a file named ‘photos’ to an external storage device,” or “save data from files in main memory, static memory, or firmware named ‘preferences’ to an external storage device or to user backup data,” have non-zero lexical similarity search scores.

In some embodiments, the hardware processor 302 may execute code instructions for the lexical similarity search module 388 to identify all data storage capabilities associated with a lexical similarity search score above a threshold value (e.g., 0.05. 0.1, 0.2) as best match data storage capabilities or other secondary OS capabilities for execution by the secondary lightweight OS 385 in response to the received user query input. In the example embodiment, the hardware processor 302 may execute code instructions for the lexical similarity search module 388 to identify a single data storage capability associated with a highest lexical similarity search score in comparison to lexical similarity search scores for all other secondary OS capabilities stored within the partitioned natural language capability library 389 as a best match data storage capability for execution at by the secondary lightweight OS 385 in response to the received user query input.

The hardware processor 302 executing machine readable code instructions of the secondary OS AI productivity tool 380 may determine whether the identified best match data storage capability, if one is made, includes backing up specified data prior to execution of the secondary OS capability 382 identified from the main OS level semantic search by the OTB AI productivity tool prior to reboot and stored in the non-volatile shared memory mailbox location 381 reserved in RAM or a disk partition of static memory or a drive unit. If the user does not provide any additional user instruction, via a user query input, for backing up specified data and no best match data storage capability is identified, the secondary OS AI productivity tool 380 may execute the best match secondary OS capability 382, via execution of code instructions of the secondary lightweight OS 385, that was identified from the main OS level semantic search by the OTB AI productivity tool prior to reboot and stored in the non-volatile shared memory mailbox location 381. In an embodiment where additional chat session user query inputs are received after reboot, the secondary OS AI productivity tool 380 may then, independently of the main operating system, instruct the secondary lightweight OS 385 to perform the best match data storage capability, or some other secondary OS capability in response to the user query input received via the secondary OS conversational interface 386.

Following execution of a best match data storage capability, in the case where the user has provided additional user query input(s) after reboot and selected for such transfer of data (e.g., 314) to an external memory device 320, the secondary OS AI productivity tool 380 in an embodiment may prompt the user, via the secondary OS conversational interface 386 and the secondary OS AI productivity tool 380, for final approval to execute the best match secondary OS capability 382 from the main OS level stored in non-volatile shared memory mailbox location 381 by the OTB AI productivity tool in response to the user query input received at the main OS level prior to reboot. For example, the secondary OS AI productivity tool 380 may request the user to confirm execution of processes by the secondary lightweight OS 385 for responsive capability intent actions such as disk wiping, disk cloning, resetting the main operating system, or repairing a hardware component (e.g., fan 392 or fan firmware 393) via the secondary lightweight OS 385, or others prior to execution of such a process. Upon receipt of user confirmation in embodiments herein, the secondary OS AI productivity tool 380 may execute the best match secondary OS capability 382 identified from the non-volatile shared memory mailbox location 381 as identified and stored there by the OTB AI productivity tool prior to reboot into the secondary lightweight OS 385. In such a way, the OTB AI productivity tool operating at the main OS level may orchestrate execution of a responsive capability intent process for a secondary lightweight OS 385 capability, such as disk wiping, disk cloning, resetting the main operating system, repairing a hardware component via the secondary lightweight OS 385, or backing up specifically identified data to an external memory device 320 in embodiments herein. The non-volatile shared memory mailbox location 381 is used to provide such secondary OS capabilities identified at an OS level, and execute such responsive secondary OS capability actions by the secondary lightweight OS 385 via the secondary OS AI productivity tool 380 following a reboot into the BIOS.

The hardware processor 302 executing machine readable code instructions of the secondary lightweight OS 385 stored in a separately partitioned section of the disk (e.g., 303 or 305) for the information handling system than the disk portion initially storing the main operating system code instructions (e.g., 314) may determine whether the portion of the disk (e.g., 303 or 305) that previously contained the main operating system code instructions (e.g., 314) has been deleted or wiped. If the main operating system code instructions (e.g., 314) have been wiped from the disk (e.g., 303 or 305), the information handling system may be prepared for recycling or reuse by another user.

In some cases, proper execution of secondary OS capabilities identified by the secondary OS AI productivity tool 380 that require reboot into BIOS and secondary lightweight OS 385 may require multiple reboots between the secondary lightweight OS 385 and the main OS. In such a case, following execution of the best match secondary OS capability 382, as described directly above, the secondary OS AI productivity tool 380 may store an execution log detailing execution of the secondary OS capability 382 with the secondary lightweight OS 385, as well as an updated user chat session history that includes all communications with the user via the secondary OS conversational interface 386 that occurred following reboot into the secondary lightweight OS 385. The secondary OS AI productivity tool 380 has access and may store this information in the non-volatile shared memory mailbox location 381 that will also be accessible to the OTB AI productivity tool after reboot to the main OS level. This may be performed in anticipation of reboot from secondary lightweight OS 385 and back into the main OS. Such data may be stored in non-volatile shared memory mailbox location 381 and is accessible by both the secondary OS AI productivity tool 380 and the OTB AI productivity tool (e.g., 250 of FIG. 2) at the main OS level in an embodiment, as described above with respect to FIG. 2. The secondary OS AI productivity tool 380 in an embodiment may then initiate reboot back into the main OS, whereupon the OTB AI productivity tool (250 of FIG. 2) may retrieve such data and continue the user chat session via the universal user conversational interface software application executing at the main operating system level, as described in greater detail above with respect to FIG. 2. In such a way, the OTB AI productivity tool may work in tandem with the secondary OS AI productivity tool 380 to maintain an ongoing user chat session throughout one or more reboots between the OS and the secondary lightweight OS 385.

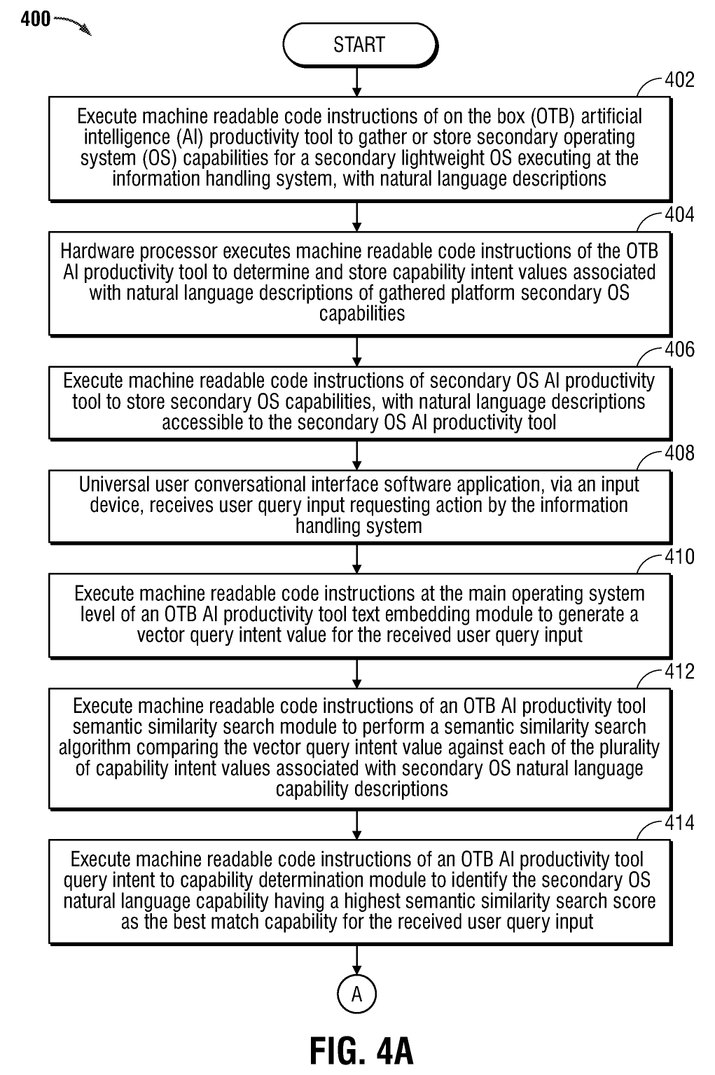

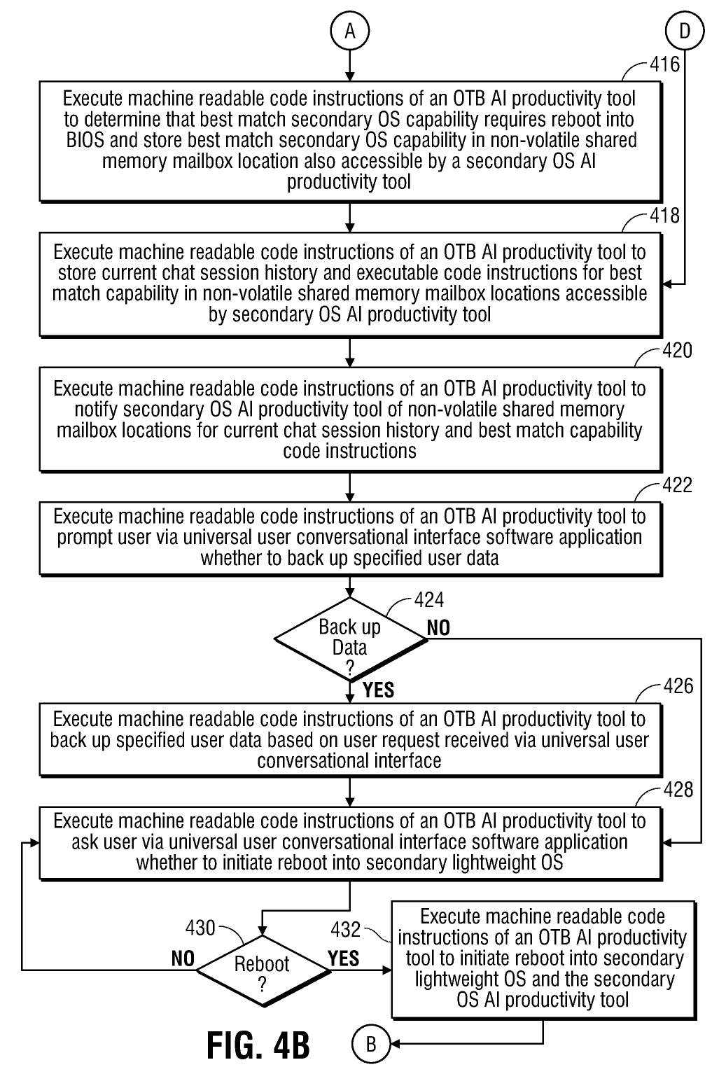

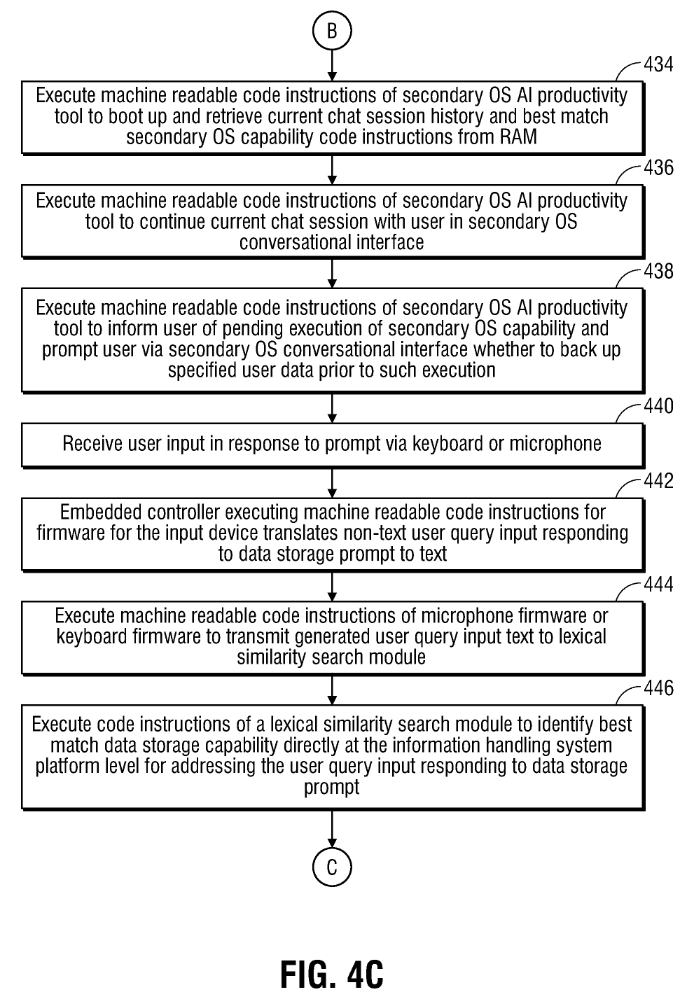

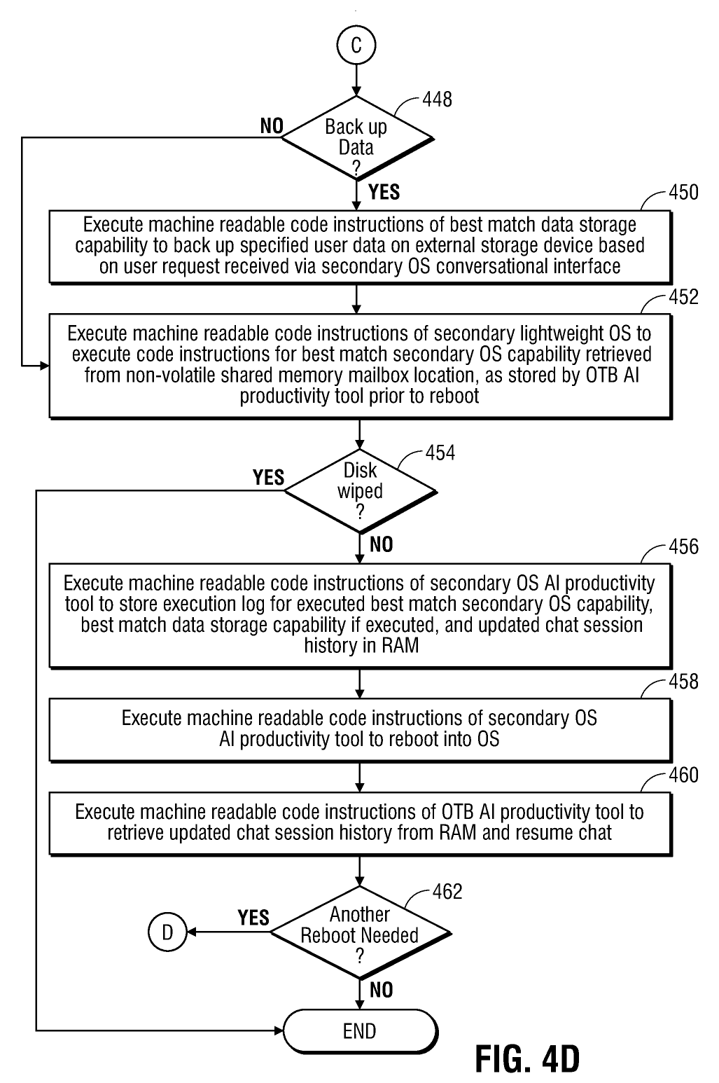

FIGS. 4A, 4B, 4C, and 4D are a flowchart 400 showing a method of automating reboot into a basic input output system (BIOS) and execution of a secondary lightweight OS, via an on the box (OTB) artificial intelligence (AI) productivity tool executing at the main operating system (OS) level for executing responsive secondary OS capabilities to a user query input according to embodiments of the present disclosure. Further, the OTB AI productivity tool and a secondary OS AI productivity tool maintain an ongoing user chat session across the main OS and the secondary lightweight OS via non-volatile shared memory mailbox location according to an embodiment of the present disclosure. It is appreciated that the method 400 described herein may be executed via execution of computer readable program code instructions in firmware or software by a hardware processor or other hardware processing resources on an information handling system.

The method 400 may include, at block 402, a hardware processor executing machine readable code instructions of the OTB AI productivity tool at the main operating system to gather secondary OS capabilities for a secondary lightweight OS executing separately from the main OS when the main OS cannot be executed, with natural language descriptions. For example, in an embodiment described with respect to FIG. 2, a hardware processor 202 executing machine readable code instructions for an on the box (OTB) AI productivity tool 250 may gather, either in real-time or prior to execution of the OTB AI productivity tool 250 as established by a manufacturer or an ITDM, via the capabilities gathering module 253, secondary OS capabilities associated with, such as published by the secondary lightweight OS 285. Additionally, capabilities of AI productivity tool-enableable software applications may also be gathered. These secondary OS capabilities may describe those functionalities of the secondary lightweight OS 285, that may be used when interfacing with the OTB AI productivity tool 250 and the secondary OS AI productivity tool 280. These natural language descriptions of the secondary OS capabilities may be stored within a natural language capability database 255 for comparison to received user query inputs, for example, in order to identify a secondary OS capability most likely to address a user’s request within the received user query inputs.

At block 404, a hardware processor in an embodiment may execute machine readable code instructions of the OTB AI productivity tool at the main operating system level to determine capability intent values associated with natural language descriptions of the gathered secondary OS capabilities as well as AI productivity tool-enableable software application capabilities . For example, as described with FIG. 2, the hardware processor 202 executing machine readable code instructions of the OTB AI productivity tool 250 may determine capability intent values associated with natural language descriptions of the gathered secondary OS capabilities. Further, the hardware processor 202 executing machine readable code instructions of the OTB AI productivity tool 250 may determine capability intent values associated with natural language descriptions of the AI productivity tool-enableable software application capabilities available at the main OS level as well. These capability intent values are a mathematical representation of the natural language descriptions of capability operations or services from the secondary lightweight OS 285 and AI productivity tool-enableable software applications in an embodiment. These capability intent values may be represented by a mathematical value in a multi-axis vector space that may be associated with the natural language description for that secondary OS capability or intent and AI productivity tool-enableable software application capabilities. In an embodiment, the secondary OS capabilities and AI productivity tool-enableable software application capabilities may also be associated with an identification (ID) such as an alphanumeric ID that may be stored within a capability intent values database 256.

The secondary OS capabilities stored at the capability intent values database 256 may include any input and output capabilities provided by the secondary lightweight OS 285 being executed by the hardware processor 202 or any other hardware processing devices, such as embedded controller 204 at the platform level of the information handling system. Generating such capability intent values as vectors may be a first step in a natural language processing method to determine a secondary OS capability, from among plural capabilities including AI productivity tool-enableable software application capabilities, corresponding to and responsive to the user’s intent or requested action within a user query input that takes into account the context or semantics of the words used within the user query input.

At block 406, additional native secondary OS capabilities may be stored in memory accessible to the secondary lightweight OS for access by execution of code instructions of a secondary OS AI productivity tool operating at the secondary lightweight OS after reboot to BIOS. In a further embodiment, a hardware processor executing machine readable code instructions of a secondary OS AI productivity tool operating at the secondary lightweight OS in an embodiment at block 406 may store native secondary OS capabilities including data storage capabilities, with natural language descriptions, at a natural language capability library stored at memory accessible by the secondary lightweight OS during operations. For example, in an embodiment described with respect to FIG. 3, the data storage capabilities among other native secondary OS capabilities may be stored within the partitioned natural language capability library 389 within partitioned memory accessible by the secondary lightweight OS. These data storage capabilities, for example, may describe data storage tasks that may be used when interfacing with the secondary OS AI productivity tool 380. The natural language descriptions of the data storage capabilities as well as other native secondary OS capabilities may be stored for a lexical or keyword comparison, via the hardware processor 302 to received user query inputs, for example, in order to identify a data storage capability or other native secondary OS capabilities at the secondary lightweight OS most likely to address a user’s request within the user query inputs received via the secondary OS conversational interface 386 at the secondary OS AI productivity tool 350.

In an embodiment at block 408, the universal user conversational interface software application executing at the main OS level, via an input device, may receive a user query input requesting action by the information handling system. For example, in an embodiment described with respect to FIG. 2, the user may provide a user query input via an input device, which may be transmitted to the universal user conversational interface software application 270 of the OTB AI productivity tool 250 executing at the main OS level 213 in an embodiment.

At block 410, the hardware processor operating at the main operating system level in an embodiment may execute machine readable code instructions of an OTB AI productivity tool text embedding module to generate a vector query intent value for the received user query input. For example, in an embodiment described with respect to FIG. 2, the hardware processor 202 executing machine-readable code instructions for the intent recognition pipeline machine learning module 261 may orchestrate any combination of a plurality of machine learning modules (e.g., 263, 265, or 266) to process the audio or text input to determine the user’s intended goal or query intent within the received text or voice data of the user query input.

During operation for example, the hardware processor 202 executing machine-readable code instructions of the query intent determination module 251 may load one or more machine learning models such that, for example, the text or voice input from the user may be processed through a speech recognition model 263 and/or processed through any of a plurality of natural language models (e.g., 265 or 266) or other ML models in order to determine a text of a user’s input query or an intent value of the user’s input query. For example, an automatic speech recognition (ASR) module 263, a text embedding module 265, or a semantic similarity search module 266 that work in various combinations with one another to detect a user’s audio speech input, conversion to text or detecting text, and detecting an intent, represented by generating a query intent vector value from the text of the user query input received from the universal user conversational interface software application 270 or other interface such as one specific to an AI productivity tool enableable software application. Further, the hardware processor 202 executing machine-readable code instructions of an intent recognition pipeline machine learning module 261 may orchestrate the interplay between each of the ASR module 263, text embedding module 265, and semantic similarity search module 266 to establish a query intent vector value in a multi-axis vector space defined with these machine learning models and correlate that query intent value with a corresponding capability intent value in an embodiment. The hardware processor 202 executing machine-readable code instructions of the intent recognition pipeline machine learning module 261 in an embodiment may apply the text embedding module 265 to generate a query intent value as described and then return the output query intent value of the text embedding module 265 to the query intent to capability determination module 252.

At block 412, the hardware processor in an embodiment may execute machine readable code instructions of an OTB AI productivity tool semantic similarity search module to perform a semantic similarity search algorithm comparing the vector query intent value against each of the plurality of vector capability intent values associated with natural language secondary OS capability descriptions and AI productivity tool-enableable software application capability descriptions. For example, in reference to an embodiment described with reference to FIG. 2, a hardware processor 202 may execute machine readable code instructions for a semantic similarity search module 266, via a query intent to capability module 252, that compares the vectorized user query input intent value and the capability intent values stored within the capability intent values database 256. Such a comparison may be performed using a semantic search machine learning model, such as a cosine or other semantic similarity search algorithm that compares the distance or value difference in a multi-axis vector space between two vectors to determine the contextual similarity between the natural language description of the embedded text algorithm generated capabilities having the capability intent values and the natural language user query input having an user query input intent value generated from an embedded text algorithm. Such a contextual or semantic search machine learning model may take into account the fact that the same word may have two meanings or consider synonyms of words, for example based on generated intent values of multiple words or recognized phrases or parts of speech that yield the vector intent value from the text embedding algorithm machine learning models used to generate capability and query intent vector values. The cosine similarity search comparison or other semantic similarity search algorithm may be performed for several of the capability intent values stored within the capability intent value database 256 to identify a best match secondary OS capability intent value that most closely matches the user query input value, according to embodiments herein.

A hardware processor 202 executing machine readable code instructions for a semantic similarity search module 266 may determine a distance, that is a value difference of the vector intent values within the multi-axis vector space between the query input intent value and each of a plurality of capability intent values. Then, for each of those determined distances, the hardware processor executing machine readable code instructions for a semantic similarity search module 266 may determine an angular similarity having a value between zero and one for the query input intent value and each of a plurality of capability intent values. This angular similarity value in an embodiment may comprise the semantic similarity search score for a given capability intent value, where zero is a worst match and one is a best match between the given capability intent value and the query input intent value.

The hardware processor in an embodiment at block 414 may execute machine readable code instructions of an OTB AI productivity tool query intent to capability determination module to identify the natural language secondary OS capability or AI productivity tool-enableable software application capability having a highest semantic similarity search score. In embodiments described herein, the OTB AI productivity tool may determine that a secondary OS capability is a best match among both secondary OS capabilities and AI productivity tool-enableable software application capabilities for the received user query input. For example, in an embodiment described with reference to FIG. 2, the query intent to capability module 252 may utilize the semantic similarity search module 266 for a correlation between the query intent value received and a stored capability intent value for a best match secondary OS capability.

More specifically, the user query intent value for the natural language description user query input “reset my main operating system” may be associated with a capability for erasing and reinstalling the main operating system 213, based on similarity correlation between the associated query intent value and a capability intent value for a secondary OS capability as determined by the semantic similarity search module 266. In another example, the query intent value for the natural language description user query input “retire my system” or “erase my data” may be associated with a capability intent value for a secondary OS capability for erasing all data, other than the partitioned portion storing machine readable code instructions for the secondary lightweight OS and the secondary OS AI productivity tool or other reserved backup data from all local memory devices. In another example, the user query intent value for the natural language description of a user query input “fix my fan” may be associated with a capability intent value for a secondary OS capability for instructing firmware to perform maintenance on the fan separate and apart from the main OS. In still another example, the user query intent value for the natural language description of a user query input “back up my data” may be associated with a capability intent value for a secondary OS capability for storing some or all data on local memory devices onto external memory devices. As described above, these secondary OS capabilities may be registered and associated at the capability intent value database 256 at the main OS level 213 along with plural AI productivity tool-enableable software application capabilities in an embodiment.

At block 416, the hardware processor in an embodiment may execute machine readable code instructions of an OTB AI productivity tool to determine that best match secondary OS capability identified as responsive to the received user query input requires reboot into a secondary lightweight OS. As described herein, in some cases, execution of the best match secondary lightweight OS may require reboot into BIOS and the secondary OS AI productivity tool. For example, capability intent actions associated with secondary OS capabilities such as disk wiping, disk cloning, resetting the main operating system, and repairing a hardware component (e.g., audio microphone 195, keyboard 190, fan 192, display device 194, or other input/output device 199 of FIG. 1) via the secondary lightweight OS 185 require the main OS 113 to not operate and may be performed by booting into BIOS and opening a secondary lightweight OS for operating as a lightweight canned service OS for a limited set of tasks. The OTB AI productivity tool at the main OS level in an embodiment may be capable of identifying the best match secondary OS capability as one of these tasks requiring reboot into the BIOS and the secondary lightweight OS, and may orchestrate the reboot into BIOS for execution of the best match secondary OS capability following such a reboot at the secondary lightweight OS.

The OTB AI productivity tool may store the user query input received at the main OS level as well as the best match secondary OS capability and instructions to execute the same at a non-volatile shared memory mailbox location set aside in RAM or a disk partition in embodiments herein. This may be done prior to reboot to BIOS. This non-volatile shared memory mailbox location set aside in RAM or a disk partition is accessible by both the OTB AI productivity tool at the main OS level and the secondary OS AI productivity tool in the secondary lightweight OS enabling them to work in tandem during the reboot to secondary lightweight OS from OS or any following reboots between the OS and the secondary lightweight OS until the users query input has been satisfied.

The hardware processor in an embodiment at block 418 may execute machine readable code instructions of an OTB AI productivity tool to store a current chat session history as well as the executable code instructions for the best match secondary OS capability in the non-volatile shared memory mailbox location set aside in RAM or a disk partition accessible to the OS as well as the secondary OS AI productivity tool executing on the secondary lightweight OS when the main OS is unavailable. For example, the OTB AI productivity tool in an embodiment may save an executable version of the best match secondary OS capability into the non-volatile shared memory mailbox location set aside in RAM or a disk partition as described above in block 416.

Additionally, in embodiments herein, the OTB AI productivity tool and the secondary OS AI productivity tool may work in tandem to maintain an ongoing user chat session throughout one or more reboots between the OS and the secondary lightweight OS, as needed for proper execution of the best match secondary OS capabilities identified as responsive to received user query inputs. This ongoing chat session and a transaction log of any responsive capability intent actions performed may also be stored in the non-volatile shared memory mailbox location set aside in RAM or a disk partition by either the secondary OS AI productivity tool or OTB AI productivity tool at the main OS level for maintaining information handling system status data, such as for settings, or even for required follow-up actions. For example, prior to reboot into BIOS and the secondary lightweight OS, the OTB AI productivity tool operating at the main OS may store in the non-volatile shared memory mailbox location set aside in RAM or a disk partition accessible by the secondary OS AI productivity tool, a current chat session history, including all communications with the user transmitted and received via the universal user conversational interface software application at the main OS level in the current user chat session, including the received user query input from which the best match secondary OS capability has been determined. Upon storage of the current chat session including the current user query input and any best match secondary OS capabilities identified as responsive at the main OS level in the non-volatile shared memory mailbox location, the OTB AI productivity tool may execute to trigger a reboot as described below in block 428 if data backup is not needed first. The identified best match secondary OS capabilities identified as responsive will include a trigger reboot flag to indicate to the OTB AI productivity tool that a reboot will be necessary.

At block 420, the hardware processor in an embodiment may execute machine readable code instructions of an OTB AI productivity tool to notify the secondary OS AI productivity tool executing in the secondary lightweight OS of the non-volatile shared memory mailbox location set aside in RAM or a disk partition for the current chat session history and the best match secondary OS capability identification. For example, an instruction for the secondary OS AI productivity tool to orchestrate execution of such a saved best match secondary OS capability may also be stored in the non-volatile shared memory mailbox location set aside in RAM or a disk partition by the OTB AI productivity tool at block 416. Retrieval and execution of the saved best match secondary OS capability and the chat history by the secondary OS AI productivity tool from the non-volatile shared memory mailbox location set aside in RAM or a disk partition occurs following reboot from the OS to the BIOS and the secondary lightweight OS. This storage of data in the non-volatile shared memory mailbox location set aside in RAM or a disk partition enables orchestration of best match secondary OS capabilities at the secondary lightweight OS by the OTB AI productivity tool.

The hardware processor in an embodiment at block 422 may execute machine readable code instructions of an OTB AI productivity tool to prompt a user via the universal user conversational interface software application whether to back up specified user data in one embodiment. For example, the hardware processor in an embodiment may execute machine readable code instructions of an OTB AI productivity tool to prompt a user via the universal user conversational interface software application whether to back up specified user data. More specifically, a user may provide a natural language user query input response confirming a prompt such as “back up the hard drive?,” “back up photos?,” or back up user preferences.”

In another embodiment discussed below, the embedded controller executing code instructions of the secondary OS AI productivity tool after reboot may prompt a user via a secondary OS conversational interface whether to back up specified user data when a saved best match secondary OS capability is identified from the non-volatile shared memory mailbox location that may cause data to be erased. In such an embodiment, blocks 422, 424, and 426 may occur instead after reboot to BIOS and secondary lightweight OS (e.g., at blocks 442-450). In the latter embodiment, the hardware processor may execute machine readable code instructions of the secondary OS AI productivity tool to prompt a user at the secondary lightweight OS as to whether to back up specified user data. More specifically, a user may provide a natural language user query input response confirming a prompt such as “back up the hard drive?,” “back up photos?,” or back up user preferences.”

Proceeding to block 424 in an embodiment, the hardware processor may determine whether the user has responded to the prompt to backup specified user data. If the user chooses or requests one of these data storage options, the OTB AI productivity tool in an embodiment may instruct transfer or copying of such user-specified data. If the user has chosen to back up specified user data, the method may proceed to block 426 for execution of such a backup action for specified data. If the user has not chosen to back up specified user data, the method may proceed to block 428 to ask the user whether to reboot into the secondary lightweight OS.

In an embodiment at block 426 in which the user has selected to back up specified data, the hardware processor may execute machine readable code instructions of an OTB AI productivity tool to back up the specified user data based on the user request received via the universal user conversational interface. For example, the hardware processor executing machine readable code instructions for the OTB AI productivity tool may save some or all data from main memory or static memory to an external storage device, save data from a specifically user-identified file to an external storage device, or save data from files in main memory, static memory, or firmware named ‘preferences’ to an external storage device or to user backup data in the non-volatile shared memory mailbox location reserved in RAM or partitioned disk space.

At block 428, the hardware processor may execute machine readable code instructions of an OTB AI productivity tool to ask the user, via the universal user conversational interface software application, whether to initiate reboot into the secondary lightweight OS. For example, the hardware processor may execute machine readable code instructions of the OTB AI productivity tool to ask the user, via the universal user conversational interface software application whether to initiate reboot into BIOS to execute responsive capability intent actions with the secondary lightweight OS. Requesting confirmation of a request to reboot into the BIOS and secondary lightweight OS 285 may provide the user a chance to store any unsaved work or data prior to performing such a reboot, for example, according to the above.

The hardware processor executing machine readable code instructions of the OTB AI productivity tool in an embodiment at block 430 may determine whether the user has selected to immediately reboot into BIOS for execution of responsive capability intent actions by the secondary lightweight OS. If the user has chosen not to immediately reboot into the secondary lightweight OS, the method may proceed back to block 428 to prompt the user to select when to initiate the reboot into the secondary lightweight OS. For example, if the user has chosen not to immediately reboot into BIOS, the OTB AI productivity tool may initiate a timer, at the end of which it may prompt the user again to select when to initiate the reboot into BIOS and secondary lightweight OS for execution of the best match secondary OS capability as the responsive capability intent action. If the user has chosen to immediately reboot into the BIOS to perform the responsive capability intent action with the secondary lightweight OS, the method may proceed to block 432 to initiate the reboot.

At block 432, the hardware processor in an embodiment may execute machine readable code instructions of an OTB AI productivity tool to initiate reboot into BIOS pursuant to the reboot flag associated with the best match secondary OS AI productivity tool capability identified as responsive to the user query input at the main OS level. For example, in an embodiment, if the user has chosen to immediately reboot into BIOS and secondary lightweight OS for execution of the best match secondary OS capability, hardware processor executing code instructions of the OTB AI productivity tool may initiate the reboot. The method may then proceed to block 434 of FIG. 4C.

In an embodiment at block 434 of FIG. 4C, the hardware processor executing the secondary lightweight OS to boot up may execute machine readable code instructions of a secondary OS AI productivity tool to retrieve the current chat session history and best match capability code instructions from the non-volatile shared memory mailbox location reserved in RAM or partitioned disk space, as stored by the OTB AI productivity tool. For example, in an embodiment described with respect to FIG. 3, upon reboot into BIOS and secondary lightweight OS 385 and automatic startup of the secondary OS AI productivity tool 380 in an embodiment, the secondary OS AI productivity tool 380 may retrieve the stored chat session history 384 from the non-volatile shared memory mailbox location 381 and continue the user chat session initiated at the main OS level via a secondary OS conversational interface 386. Upon reboot to BIOS and secondary lightweight OS 385, the secondary OS AI productivity tool 380 executes to determine if a general reboot is to occur or if responsive capability intent actions are to be performed by best match secondary OS capabilities stored in the non-volatile shared memory mailbox location 381. The secondary OS AI productivity tool 380 has either a hidden secure memory drive location or a secure pull down location from RAM that it is directed to check in embodiments herein. Then the AI productivity tool 380 retrieves the best match secondary OS capability or capabilities from the non-volatile shared memory mailbox location 381, if any. Otherwise, the BIOS may continue to a dashboard 387 for the secondary lightweight OS 385 in embodiments herein.

At block 436, the embedded controller in an embodiment may execute machine readable code instructions of a secondary OS AI productivity tool to continue a current chat session inside a secondary OS conversational interface initially started in the OTB AI productivity tool universal user conversational interface software application with the user prior to reboot into the secondary lightweight OS. The user, via this secondary OS conversational interface 386, as shown in FIG. 3, may then request execution of further secondary lightweight OS 385 capabilities, such as data backup in another embodiment. This may occur prior to execution of the best match secondary OS capability 382 identified at the main OS level by the OTB AI productivity tool (250 of FIG. 2) as responsive to the user query input received at the main OS level that occurred prior to reboot into the BIOS and secondary lightweight OS 385. The user may also use this secondary OS conversational interface 386 to provide final approval for execution of the best match secondary OS capability 382 in another example embodiment.

At block 438, the embedded controller may execute machine readable code instructions of the secondary OS AI productivity tool to inform the user of a pending execution of a secondary OS capability identified and stored in RAM by the OTB AI productivity tool and prompt the user via the secondary OS conversational interface whether to back up specified user data prior to such execution. For example, the embedded controller may execute machine readable code instructions of the secondary OS AI productivity tool to inform the user of a pending execution of a secondary OS capability identified and stored in the non-volatile shared memory mailbox location 381reserved in RAM or partitioned disk space by the OTB AI productivity tool prior to reboot. At this point, in an embodiment, the secondary OS AI productivity tool may prompt the user via the secondary OS conversational interface whether to back up specified user data prior to such execution and whether to proceed with execution of the best match secondary OS capability as the responsive capability intent action to the original user query input.

At block 440, user input may be received in response to the prompt described above with respect to block 438, via the keyboard or microphone. For example, the secondary OS conversational interface in an embodiment may receive a user query input requesting storage or back up of data. Such a user query input may be made in voice format via the microphone, or in text format, for example, via the keyboard. Upon receipt of the user query input via a hardware component, such as the microphone, keyboard, or other input/output devices, the secondary OS AI productivity tool may operate at the secondary lightweight OS, separate and apart from the universal user conversational interface software application (which may operate at the main operating system level in other embodiments for back up instructions such as at block 422 above) to identify which of the data storage capabilities of the secondary lightweight OS is requested by the user within the user query input. A hardware processor executing code instructions of the secondary OS AI productivity tool in an embodiment may match these received user queries, or user query inputs from the microphone, and keyboard to known secondary OS capabilities, such as a data storage capability for back up of data in an embodiment herein.

Upon receipt of a user query input by the secondary OS AI productivity tool and secondary OS conversational interface in embodiments herein, the received user query input data (audio, video or text) is routed from the embedded controller or other hardware controller from the microphone, keyboard, or other input to the secondary lightweight OS for determination of a user’s instruction to store or backup data to an external memory device or to the non-volatile shared memory mailbox location reserved in RAM or partitioned disk space in the form of user backup data. Data may be stored in either the external hard drive or user backup data at the non-volatile shared memory mailbox location reserved in RAM or partitioned disk space, for example, if the user wishes to reset or replace the main operating system, then migrate previously stored user data back to the newly installed main operating system. The hardware processor will execute the secondary OS AI productivity tool at the secondary lightweight OS to match the received user query input to a data storage capability using lexical similarity determination for a user query intent and matching the user query intent to a natural language library of available data storage capabilities according to embodiments herein.

At block 442, in an embodiment, an embedded controller executing machine readable code instructions for firmware for the input device may translate received non-text user query input to text for executing keyword spotting of particular keywords from the text. This keyword spotting may also occur from direct text entry such as with a keyboard. For example, in an embodiment described with respect to FIG. 3, firmware 396 or 391 for the receiving input device, such as the microphone 395, or the keyboard 390 respectively, may translate audio user query input to text and transmit the text user query input, via embedded controller directly to the secondary OS AI productivity tool 380. The keyboard 390 may provide for the text user query input to the secondary OS AI productivity tool 380. Upon detection of receipt of such a user query input at firmware (e.g., microphone firmware 396, or keyboard firmware 392) for the microphone 395, or keyboard 390 in an embodiment, this audio user query input may be translated to text via firmware of the microphone 395, or keyboard 390, respectively. For example, the microphone firmware 396 may include a microphone automated speech recognition (ASR) module 397 to detect words within the recorded voice data and generate text representing the detected words.

An embedded controller or other hardware controller executing at an information handling system platform level (separately from the main operating system (OS)) in an embodiment at block 444 may execute machine readable code instructions of firmware for the input device to transmit the generated or existing user query input text to a lexical similarity search module at the secondary lightweight OS and the secondary OS AI productivity tool. For example, in an embodiment in which the input device is microphone, the microphone firmware may execute to transmit the text user query input translated from captured audio to the lexical similarity search module executing as part of the secondary OS AI productivity tool by the hardware processor at the secondary lightweight OS.

At block 446 in an embodiment, the hardware processor at the secondary lightweight OS may execute code instructions of a lexical similarity search module to match natural language text keywords of received user query input with a natural language description of a data storage capability that most closely corresponds and can address the user request within the user query input. For example, the hardware processor instructions of a lexical similarity search module of the secondary OS AI productivity tool in an embodiment may perform a lexical similarity search method to match the natural language text of the received user query input with a natural language description of a data storage capability stored in the natural language capability library in order to identify a data storage capability that most closely corresponds and can address the user request within the user query input.

In an example embodiment, the hardware processor executes code instructions for the lexical similarity search module may perform a TF-IDF algorithm in the secondary OS AI productivity tool to measure the frequency with which each of a plurality of natural language terms appear within the user query input, as weighted by the frequency with which that term occurs in one of each of the natural language data storage capabilities stored within the natural language capability library. This comparison may be repeated for each of the data storage capabilities stored within the natural language capability library, to produce a lexical similarity search score for each of the data storage capabilities to one or more keywords detected in the user query input data. For example, a user may provide a natural language user query input such as “back up my hard drive,” “back up my photos,” or back up my user preferences” in response to being prompted as to whether to back up any data. In such a scenario, the hardware processor 302 executing code instructions for the lexical similarity search module may determine that data storage capabilities stored within the natural language capability library such as “save all data from main memory and static memory to an external storage device,” “save data from a file named ‘photos’ to an external storage device,” or “save data from files in main memory, static memory, or firmware named ‘preferences’ as backup” may be stored to an external storage device or to user backup data in the non-volatile shared memory mailbox location reserved in RAM or partitioned disk space 381, have non-zero lexical similarity search scores.

At block 448, the hardware processor executing machine readable code instructions of the secondary OS AI productivity tool at the secondary lightweight OS may determine whether the identified best match data storage capability includes backing up specified data prior to execution of the secondary OS capability stored in the non-volatile shared memory mailbox location reserved in RAM or partitioned disk space by the OTB AI productivity tool before reboot. For example, the hardware processor executing machine readable code instructions of the secondary OS AI productivity tool may determine whether the identified best match data storage capability, if one is made, includes backing up specified data prior to execution of the secondary OS capability stored in the non-volatile shared memory mailbox location reserved in RAM or partitioned disk space by the OTB AI productivity tool prior to reboot. If the user does not provide a user instruction for backing up specified data and no best match data storage capability is identified, the secondary OS AI productivity tool may execute the best match secondary OS capability stored in the non-volatile shared memory mailbox location reserved in RAM or partitioned disk space via execution of code instructions of the secondary lightweight OS. If the identified best match secondary OS capability includes backing up specified data, the method may proceed to block 450 for such back up. If the identified best match secondary OS capability does not include backing up specified data, the method may proceed to block 452 for execution of the best match secondary OS capability stored in RAM by the OTB AI productivity tool prior to reboot into the secondary lightweight OS.

At block 450, in an embodiment in which the identified best match data storage capability includes backing up specified data, the hardware processor may execute machine readable code instructions of the secondary OS AI productivity tool to back up specified user data on an external storage device or at the non-volatile shared memory mailbox location reserved in RAM or partitioned disk space based on the user request received via the secondary OS conversational interface. For example, the secondary OS AI productivity tool in an embodiment may, independently of the main operating system, instruct the secondary lightweight OS to perform the best match data storage capability in response to the user query input received via the secondary OS conversational interface. The method may then proceed to block 452 for execution of the best match secondary lightweight OS stored in the non-volatile shared memory mailbox location reserved in RAM or partitioned disk space by the OTB AI productivity tool before reboot as the responsive capability intent action executed by the secondary lightweight OS in response to the original user query input received at the main OS level.

The hardware processor in an embodiment at block 452 may execute machine readable code instructions of the secondary lightweight OS to execute code instructions for the best match secondary OS capability retrieved from the non-volatile shared memory mailbox location reserved in RAM or partitioned disk space at block 434. For example, the secondary OS AI productivity tool in an embodiment may prompt the user, via the secondary OS conversational interface, for final approval to execute the best match secondary OS capability identified in the non-volatile shared memory mailbox location reserved in RAM or partitioned disk space by the OTB AI productivity tool in response to the original user query input received at the main OS level prior to reboot into BIOS. This best match secondary OS capability is a responsive capability intent action to be executed in response to the original user query input by the secondary OS AI productivity tool and execution of the secondary lightweight OS. More specifically, the secondary OS AI productivity tool may request the user to confirm execution of best match secondary OS capability processes such as disk wiping, disk cloning, resetting the main operating system, or repairing a hardware component (e.g., fan or fan firmware) via the secondary lightweight OS prior to execution of such a process. Upon receipt of user confirmation in embodiments herein, the secondary OS AI productivity tool may execute the best match secondary OS capability retrieved from the non-volatile shared memory mailbox location reserved in RAM or partitioned disk space as a responsive capability intent action to the original user query input received at the main OS level. In such a way, the OTB AI productivity tool operating at the main OS level may orchestrate execution of a responsive secondary OS capability process, such as disk wiping, disk cloning, resetting the main operating system, repairing a hardware component, or backing up specifically identified data to an external memory device, via a secondary OS AI productivity tool operating at the secondary lightweight OS at the information handling system. The orchestration occurs due to access of the non-volatile shared memory mailbox location reserved in RAM or partitioned disk space by the secondary OS AI productivity tool following a reboot into the basic input output system (BIOS) and the secondary OS AI productivity tool.

At block 454 in an embodiment, the hardware processor executing machine readable code instructions of the secondary lightweight OS stored in a separately partitioned section of the disk for the information handling system than the disk portion initially storing the main operating system code instructions may determine whether the portion of the disk that previously contained the main operating system code instructions should be deleted or wiped pursuant to a responsive best match secondary OS capability. For example, the hardware processor executing machine readable code instructions of the secondary lightweight OS stored in a separately partitioned section of memory or a static or disk drive (e.g., 303 or 305 in FIG. 3) for the information handling system than the disk portion initially storing the main operating system code instructions may determine whether the portion of the memory or disk that previously contained the main operating system code instructions has been or is to be deleted or wiped pursuant to a responsive capability intent action by the best match secondary OS capability, for example.

If the main operating system code instructions have been or are to be wiped from the disk, the information handling system may be being prepared for recycling or reuse by another user. If the main operating system code instructions have been or are to wiped from the disk, the method for automating reboot into and execution of secondary lightweight OS and maintaining the ongoing user chat session across the main OS and the secondary lightweight OS, via an OTB AI productivity tool executing at the main OS level may then end. If the main operating system code instructions have not been wiped from the disk or is to be wiped and the main OS reset at block 454, the method may proceed to block 456 for storage of a process transaction execution log detailing execution of the secondary OS capability as a responsive capability intent action and an updated chat history that includes communication with the user via the secondary OS conversational interface.

At block 456, the hardware processor in an embodiment may execute machine readable code instructions of a secondary OS AI productivity tool to store a process transaction execution log for the executed best match secondary OS capability as responsive capability intent actions and an updated chat session history in the non-volatile shared memory mailbox location reserved in RAM or partitioned disk space for retrieval by the OTB AI productivity tool following reboot back into the main operating system. In some cases, proper execution of tasks that require reboot into BIOS and the secondary lightweight OS, and the secondary OS AI productivity tool may require multiple reboots between secondary lightweight OS and the OS. In such a case, following execution of the best match secondary OS capability, as described directly above, the secondary OS AI productivity tool may store the process transaction execution log detailing execution of the secondary OS AI productivity tool capability in the secondary lightweight OS, as well as an updated user chat session history that includes all communications with the user via the secondary OS conversational interface that occurred following reboot into secondary lightweight OS. This may be performed in anticipation of reboot from the secondary lightweight OS and back into the main OS. Such data may be stored in the non-volatile shared memory mailbox location reserved in RAM or partitioned disk space accessible by both the secondary OS AI productivity tool and the OTB AI productivity tool in embodiments herein.

In an embodiment at block 458, the embedded controller may execute machine readable code instructions of the secondary OS AI productivity tool to reboot into the main OS. The secondary OS AI productivity tool in an embodiment may then initiate reboot back into the main OS, whereupon the OTB AI productivity tool may retrieve such data from the non-volatile shared memory mailbox location reserved in RAM or partitioned disk space and continue the user chat session via the universal user conversational interface software application executing at the main operating system level.

At block 460, the hardware processor may execute machine readable code instructions of the OTB AI productivity tool to retrieve the updated chat session history from the non-volatile shared memory mailbox location reserved in RAM or partitioned disk space and resume the chat, including past communication with the user received via the secondary OS conversational interface prior to reboot into the main OS. As described herein, in some cases, proper execution of tasks that require reboot into the BIOS and secondary lightweight OS may require multiple reboots between BIOS and the secondary lightweight OS and the main OS. In such a case, following execution of the best match secondary OS capability, the secondary OS AI productivity tool in an embodiment may initiate reboot back into the OS, whereupon the OTB AI productivity tool may retrieve data stored by the secondary OS AI productivity tool at block 458 and continue the user chat session via the universal user conversational interface software application executing at the main operating system level. In such a way, the OTB AI productivity tool may work in tandem with the secondary OS AI productivity tool to maintain an ongoing user chat session throughout one or more reboots between the main OS and the BIOS and secondary lightweight OS via utilization of the non-volatile shared memory mailbox location reserved in RAM or partitioned disk space.

In an embodiment at block 462, the hardware processor may execute machine readable code instructions of the OTB AI productivity tool to determine whether any further reboots into the secondary lightweight OS are required in response to user query inputs received via the OTB AI productivity tool universal user conversational interface software application executing in the OS. If further reboots into the secondary lightweight OS are not required, the method for automating reboot into and execution of secondary lightweight OS and maintaining a single user chat session across the main OS and the secondary lightweight OS, via an OTB AI productivity tool executing at the main OS level and the secondary OS AI productivity tool may then end. If further reboots into the secondary lightweight OS are required, the method may proceed back to block 418 to store the current chat session history and executable code instructions for another best match secondary OS capability for execution in the secondary lightweight OS. By repeating the loop between 418 and 462, the OTB AI productivity tool may work in tandem with the secondary OS AI productivity tool to maintain a single user chat session throughout one or more reboots between the main OS and the secondary lightweight OS.

The blocks of the flow diagram of FIGS. 4A, 4B, 4C, and 4D or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing computer readable code instructions for an on the box (OTB) artificial intelligence (AI) productivity tool comprising:
a hardware processor receiving a user query input at a main operating system (OS) level via an input/output device requesting a capability intent action to be taken by the information handling system;
the hardware processor executing computer-readable code instructions at the main OS level for generating a query input intent value for the user query input;
the hardware processor executing computer-readable code instructions for performing a semantic similarity search comparing the query input intent value to a plurality of capability intent values generated from natural language descriptions of gathered secondary OS capabilities associated with a secondary lightweight OS and capabilities associated with AI productivity tool-enableable software applications to identify a best match secondary OS capability for the received user query input having a highest semantic similarity search score, wherein the best match secondary OS capability includes erasing drive memory at the information handling system and requires rebooting from the main OS level to a basic input/output system (BIOS) and the secondary lightweight OS that executes limited tasks separate from the main OS level;
the hardware processor executing computer-readable code instructions for storing the best match secondary OS level capability in a non-volatile shared memory mailbox location reserved in random access memory (RAM) or partitioned drive space that is retrieved by a secondary OS AI productivity tool after reboot; and
the hardware processor executing computer-readable code instructions of the secondary OS AI productivity tool to execute the computer-readable code instructions for the best match secondary OS capability via the secondary lightweight OS as the responsive capability intent action to the user query input received at the main OS level.

2. The information handling system of claim 1 further comprising:
the hardware processor executing computer-readable code instructions for the universal user conversational interface software application to confirm that the user wants to erase the drive memory prior to rebooting into the secondary lightweight OS for execution of the best match secondary OS AI productivity tool capability.

3. The information handling system of claim 1 further comprising:
the hardware processor executing computer-readable code instructions for secondary OS conversational interface after reboot to confirm that the user wants to erase the drive memory prior to erasing the drive memory pursuant to the best match secondary OS capability by the secondary lightweight OS.

4. The information handling system of claim 1 further comprising:
the hardware processor executing computer-readable code instructions for the universal user conversational interface software application to receive a user instruction to move user-specified data stored on the drive memory of the information handling system to an operatively coupled external memory device in addition to the identified best match secondary OS capability; and
the hardware processor executing computer-readable code instructions for the OTB AI productivity tool to move the user-specified data from the drive memory to the operatively coupled external memory device prior to rebooting into the secondary lightweight OS to execute the best match secondary OS capability in response to the user query input.

5. The information handling system of claim 1 further comprising:
the hardware processor executing computer-readable code instructions for the secondary OS conversational interface to receive a user instruction after reboot to move user-specified data stored on the drive memory of the information handling system to an operatively coupled external memory device prior to execution of the best match secondary OS capability by the secondary lightweight OS; and
the EC executing computer-readable code instructions to move the user-specified data to the operatively coupled external memory device prior to executing the best match secondary OS capability as a responsive capability intent action to the user query input received at the main OS level.

6. The information handling system of claim 1 further comprising:
the input/output device includes a microphone for receiving a user data storage instruction to back up data stored on the drive memory to an operatively coupled external memory device in a user query input to the secondary OS AI productivity tool; and
the hardware processor executing machine readable code instructions of an automated speech recognition module at the secondary lightweight OS for translating the user data storage instruction from audio to text for matching by the secondary OS AI productivity tool to a data storage back up capability available at a partitioned natural language capability library accessible to the secondary OS AI productivity tool.

7. The information handling system of claim 1 further comprising:
the hardware processor executing computer-readable program code instructions at the secondary lightweight OS for performing a text frequency-inverted document frequency (TF-IDF) comparison between natural language of a secondary OS user query input for a user data storage instruction to back up data stored on the drive memory to an operatively coupled external memory device and each of a plurality secondary OS capabilities available at a partitioned natural language capability library accessible to the secondary OS AI productivity tool; and
the hardware processor executing computer-readable program code instructions for the secondary lightweight OS to execute a second best match secondary OS capability having a highest lexical similarity search score to back up data stored on the drive memory to an operatively coupled external memory device.

8. A method of automating reboot into and execution of a secondary lightweight operating system (OS) for execution of secondary OS capabilities comprising:
receiving a user query input at a main OS level, via an input/output device, requesting an action to be taken by the information handling system to prepare to erase a drive memory, such as a disk drive or a static memory;
executing, via a hardware processor, computer readable code instructions for an on the box (OTB) artificial intelligence (AI) productivity tool executing at the main OS level to determine a best match secondary OS capability at a secondary lightweight OS to erase the drive memory that requires a reboot;
storing the determined best match secondary OS capability for the secondary lightweight OS to erase the drive memory in a non-volatile shared memory mailbox location reserved and partitioned in a random access memory (RAM) or a partitioned drive memory space;
retrieving, via hardware processor executing computer-readable code instructions of a secondary OS AI productivity tool at the platform level, from the non-volatile shared memory mailbox location reserved in the RAM or the partitioned drive memory space the best match secondary OS capability for the secondary lightweight OS to erase the drive memory except the partitioned drive memory space;
notifying a user of imminent execution of the best match secondary OS capability for the secondary lightweight OS to erase the drive memory for the information handling system, via the hardware processor executing computer-readable code instructions of a secondary OS conversational interface of the secondary OS AI productivity tool;
receiving a secondary OS user query input from the user at the secondary OS conversational interface for a user data storage instruction to back up data stored on the drive memory to an external memory device prior to erasing the drive memory via the best match secondary OS capability; and
executing computer-readable code instructions for a best match backup capability of the secondary lightweight OS to back up data stored on the drive memory and for the best match secondary OS capability to erase the drive memory via the hardware processor executing computer-readable code instructions of secondary lightweight OS.

9. The method of claim 8 further comprising:
receiving the secondary OS user query input for the user data storage instruction, via a microphone; and
translating the user data storage instruction from audio to text, via executing machine readable code instructions of an automatic speech recognition module.

10. The method of claim 8 further comprising:
performing a text frequency-inverted document frequency (TF-IDF) comparison, via the hardware processor executing computer-readable program code instructions, between natural language of the secondary OS user query input for the user data storage instruction and each of a plurality of natural language descriptions of secondary OS capabilities available at a partitioned natural language capability library accessible to the secondary OS AI productivity tool identify a second best match secondary OS capability that is the best match backup capability having a highest lexical similarity search score; and
executing the best match backup capability, via the hardware processor executing computer-readable program code instructions for the secondary lightweight OS to back up data stored on the drive memory.

11. The method of claim 8 further comprising:
receiving the secondary OS user query input for the user data storage instruction to back up data stored on the memory drive to the external memory device, via the secondary OS conversational interface, prior to erasing the drive memory.

12. The method of claim 8, wherein the secondary lightweight OS executes limited tasks separate from the main OS level when a main OS cannot execute for those limited tasks.

13. The method of claim 8 further comprising:
confirming, via the hardware processor executing computer-readable code instructions for the secondary OS conversational interface, that the user wants to erase the memory drive prior to erasing the drive memory via the secondary OS capability of the secondary lightweight OS.

14. The information handling system of claim 8 further comprising:
confirming that the user wants to erase the memory drive prior to booting into the secondary OS AI productivity tool, via the hardware processor executing computer-readable code instructions for the OTB AI productivity tool operating at the main OS level.

15. An information handling system executing computer readable code instructions for an on the box (OTB) artificial intelligence (AI) productivity tool comprising:
a hardware processor receiving a user query input at the main operating system (OS) level, via an input/output device, requesting a responsive capability intent action to erase drive memory to be taken by the information handling system;
the hardware processor executing computer-readable code instructions at the main OS level for generating a query input intent value for the user query input;
the hardware processor executing computer-readable code instructions or the OTB AI productivity tool at the main OS level for performing a semantic similarity search comparing the query input intent value to a plurality of capability intent values generated from natural language descriptions of gathered capabilities associated with a secondary lightweight OS and with AI productivity tool-enableable software applications to identify a best match secondary OS capability for the received user query input having a highest semantic similarity search score, wherein the secondary lightweight OS executes limited tasks separate from the main OS level when a main OS cannot execute for those limited tasks;
the hardware processor executing computer-readable code instructions for storing the best match secondary OS capability in a non-volatile shared memory mailbox location set aside in a memory drive partition that is accessible by a secondary OS AI productivity tool executing at the secondary lightweight OS;
the hardware processor executing computer-readable code instructions for rebooting into the BIOS and the secondary lightweight OS and executing the secondary OS AI productivity tool to retrieve the best match secondary OS capability to erase the drive memory from the non-volatile shared memory mailbox location set aside in the memory drive partition; and
the hardware processor executing computer-readable code instructions of the secondary lightweight OS to execute computer-readable code instructions for the best match secondary OS capability to erase the memory drive, except the memory drive partition, as the responsive capability intent action to the user query input received at the main OS level.

16. The information handling system of claim 15 further comprising:
the hardware processor executing computer-readable code instructions for the secondary OS conversational interface to prompt the user for a user data storage instruction to back up data stored on the memory drive to an operatively coupled external memory device prior to erasing the memory drive; and
the hardware processor executing computer-readable code instructions of the secondary OS AI productivity tool to execute a user instruction to back up data stored on the memory drive to an external memory device prior to erasing the memory drive.

17. The information handling system of claim 15 further comprising:
a microphone for receiving a secondary OS query input via a secondary OS conversational interface after reboot to the secondary lightweight OS that is a user data storage instruction to back up data stored on the drive memory to an operatively coupled external memory device; and
the hardware processor executing computer-readable program code instructions for identifying and executing a second best match secondary OS capability responsive to the received secondary user query input having a highest lexical similarity search score; and
the hardware processor executing machine readable code instructions of the secondary lightweight OS to back up data from the drive memory pursuant to the second best match secondary OS capability.

18. The information handling system of claim 15, wherein the best match secondary OS capability includes erasing the drive memory that includes a random access memory, a disk drive and a static memory of the information handling system to prepare the information handling system for recycling or retirement.

19. The information handling system of claim 15 further comprising:
the hardware processor executing computer-readable code instructions for the universal user conversational interface software application at the main OS level to confirm that the user wants to erase the drive memory prior to rebooting into the secondary lightweight OS and the secondary OS AI productivity tool.

20. The information handling system of claim 15 further comprising:
the hardware processor executing computer-readable code instructions for the secondary OS conversational interface to confirm that the user wants to erase the drive memory prior to executing the responsive capability intent action of erasing the drive memory.
